(19) United States
(12) Patent Application Publication
(10) Pub. No.: US 2002/0147819 A1
(43) Pub. Date: Oct. 10, 2002

(54) Method of wireless LAN parameter setting by direct contact or proximity connection between communication devices

(75) Inventors: Daisuke Miyakoshi, Yokosuka-shi (JP); Kazuhiro Muto, Ohta-ku (JP); Hitoshi Yamakado, Hino-shi (JP); Toru Miyamoto, Hachioji-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/085,044

(22) Filed: Mar. 1, 2002

(30) Foreign Application Priority Data
Mar. 27, 2001 (JP) 2001-091423
Feb. 21, 2002 (JP) 2002-045145

(51) Int. Cl. G06F 15/16

(52) U.S. Cl. 709/228

(57) ABSTRACT

First, by connecting a wireless communication terminal, which has a cable communication unit, to another wireless communication terminal, which also has a cable communication unit, via their respective cable communication units, guide information, which is required to determine communication parameters for wireless communication between said two wireless communication terminals using their respective wireless communication units, is communicated under said connection. Next, said communication parameters are determined on the basis of said guide information, and determined communication parameters are communicated under said connection. Next, said communication parameters are applied to said two wireless communication terminals automatically. Consequently, users of said two wireless communication terminals can start a wireless communication between said two wireless communication terminals.

### BACKGROUND OF THE INVENTION

For a user to connect a communication device to a Local Area Network (LAN) it is generally necessary to provide network communication protocol information on the device to the LAN administrator. The administrator then selects appropriate protocols to be used to connect the communication device. This selection is made on the basis of both protocols in use in the LAN and protocol information provided by the device user. The administrator then informs the user of necessary changes to be made to protocol parameters for connection to the LAN of the communication device.

However, since such parameter information is generally available only to a LAN administrator a user cannot implement protocol parameter changes in a communication device for connection to the LAN in the administrator's absence. In the event that such information is generally available, it remains difficult for an inexperienced user to set up necessary protocols and parameter changes. Further, it is also the case that difficulties will be encountered by even an experienced administrator in choosing suitable protocols and parameters of those protocols for setting up in a user's communication device. In selecting protocols and parameters it is necessary to take into a variety of factors such as communication speeds, processor type, memory capacity, power usage, and so on. These factors must be considered in relation not only to functional characteristics of a device to be connected, but also in relation to the overall functionality of a LAN.

As will be apparent from the foregoing description, the necessity for a method of automatically setting protocols and parameters for LAN connection is high; and in the case of a wireless LAN system the ability to be able to automatically set such connection parameters is of critical importance. There are two main reasons why the ability to be able to set LAN connection protocols and their parameters is of great importance within a wireless system.

Firstly, as compared to cable LAN systems, there are more protocols available in wireless LAN systems. While in cable systems the lower level protocol IEEE802.3 (Ethernet, Fast Ethernet) is dominant, several protocols remain popular in wireless systems. Among them there can be mentioned IEEE802.11b and Bluetooth. Moreover, several new protocols for wireless LAN such as IEEE802.15, IEEE802.16, and others, are also ready for introduction for use in wireless LAN systems. A relatively large choice of protocols in use and available for use in wireless systems obviously complicates a decision as to which protocol should best be selected; further, in considering which protocol and parameters to assign for a communication device, an administrator is also faced with the problem some protocols use the same frequency band, and thus the use of one protocol may restrict the use of another.

Secondly, wireless LANs are less secure than their cable counterparts, and data communicated is more susceptible to unauthorized access. To counteract this problem, and unlike in cable systems, it is generally necessary to implement both encryption and authentication in lower level protocols for wireless LAN systems. Authentication and encryption parameters must be manually set before a communication device is connected to wireless LAN, which is both time consuming and complicated.

### FIELD OF THE INVENTION

The present invention relates to method of parameter setting, communication terminal, access point, record medium, and program for local area networks (LANs), and more particularly to those for wireless LANs.

### DESCRIPTION OF THE RELATED ART

To make easier the task of connecting communication devices to a cable or wireless LAN system, there have been proposed in the art different methods for automating settings of parameters in middle and higher levels of protocols which are shared by cable LANs and wireless LANs. Utilization of a DHCP server is one such means. With the spread of the Internet, use of Transmission Control Protocol/Internet Protocol (TCP/IP) has become common. Use of TCP/IP requires that each communication device be allocated an IP address which is not in use by any other device connected to the LAN. Until comparatively recently, it was necessary for an administrator to allocate each IP address manually, and for a user to manually set an allocated address in a device. This procedure has been superceded in many cases by the use of a DHCP server program which is installed in a communication device. This program automatically allocates IP addresses to devices connected to a LAN and in which there is installed a DHCP client program. The client program enables a device to receive an automatically allocated IP address and automatically sets it within the device.

As mentioned, due to the security problems associated with wireless LAN systems, it is necessary to set various parameters in their lower level protocols. To reduce the difficulties associated with parameter setting procedures, a means known in the art as Automatic Frequency Channel Negotiation has been proposed and is in use. By this means, when a radio signal is received from a communication device by another device, and the signal meets prescribed conditions, the devices communicate with each other to find a frequency channel which each of them can use, and once a suitable frequency channel is found it is automatically set for use in the devices.

However, settings required for connection authentication and information encryption must still be set manually.

### SUMMARY OF THE INVENTION

The present invention has been made to overcome the stated problems of the conventional art, and has as its object the provision of a method of parameter setting for wireless LANs by which anybody can start wireless communication in the wireless LANs easily. The present invention also has the provision of apparatuses, a program, and a record medium containing said program, which are required for said method.

In accordance with an aspect of the present invention, a method of setting communication parameters may comprise: a connection step in which a first communication device is connected to a second communication device, each of which devices has a first communication unit for wireless communication, and a second, different, communication unit, said devices being connected in said connecting step via respective said second communication units; a guide information communication step in which said first communication device sends, via its second communication unit, guide information which is received by said second communication device via its second communication unit, said guide information concerning communication forms usable by said first communication unit of said first communication device; and a communication parameter determination step in which said second communication device determines on the basis of said guide information, communication parameters for use when said first communication device and said second communication device communicate via their respective first communication units.

Preferably, said method may further comprise, following completion of said communication parameter determination step, a communication parameter setting step in which said second communication device sets communication parameters determined in said communication parameter determination step, said communication parameters being used when said second communication device communicates with said first communication device via its first communication unit.

Preferably, said method may further comprise, following completion of said communication parameter determination step, a communication parameter communication step in which said second communication device sends, via its second communication unit, communication parameters determined in said communication parameter determination step, which communication parameters are received by said first communication device via its second communication unit; and a communication parameter setting step is carried out in which said first communication device sets said communication parameters, said communication parameters being used when said first communication device communicates with said second communication device via its first communication unit.

Preferably, said method may further comprise, following completion of said communication parameter determination step, a communication parameter communication step in which said second communication device sends via its second communication unit, communication parameters determined in said communication parameter determination step, which communication parameters are received by said first communication device via its second communication unit; and a communication parameter setting step is carried out in which said first communication device and said second communication device set said communication parameters, said communication parameters being used when said first communication device and said second communication device communicate via their respective first communication units.

Preferably, in said method, the connection in said connection step may be established by bringing into direct contact said second communication unit of said first communication device with said second communication unit of said second communication device.

Preferably, in said method, the connection in said connection step may be established by a shorter distance wireless communication than the wireless communication between said first communication device and said second communication device via respective said first communication units.

Preferably, in said method, said first communication device and said second communication device may be communication terminals.

Preferably, in said method, either said first communication device or said second communication device may be an access point for relaying communications when two or more other communication devices execute wireless communications.

Preferably, said method may further comprise, in said communication parameter determination step, a communication protocol selection step in which said second communication device selects one or more communication protocols, said communication protocols being used when said second communication device communicates with said first communication device via its first communication unit.

Preferably, in said method, said communication parameters may include communication protocol parameters for use in performing both wired and wireless communications.

Preferably, said method may further comprise a cryptograph key information communication step in which said first communication device sends, via its second communication unit, cryptograph key information, which cryptograph key information is received by said second communication device via its second communication unit, said cryptograph key information being used for encrypting and/or encoding information which said second communication device sends and/or receives via its first communication unit, and wherein said second communication device encrypts and/or encodes information which said second communication device sends and/or receives via its first communication unit, using said cryptograph key information.

Preferably, said method may further comprise a cryptograph key information communication step in which said second communication device sends, via its second communication unit, cryptograph key information, which cryptograph key information is received by said first communication device via its second communication unit, said cryptograph key information being used for encrypting and/or encoding information which said first communication device sends and/or receives via its first communication unit, and wherein said first communication device encrypts and/or encodes information which said first communication device sends and/or receives via its first communication unit, using said cryptograph key information.

Preferably, said method may further comprise an identifier communication step in which said first communication device sends, via its second communication unit, an identifier, which identifier is received by said second communication device via its second communication unit, said identifier being used for identifying said first communication device, and wherein said second communication device approves or rejects communications which said first communication device executes with said second communication device, using said identifier.

Preferably, said method may further comprise an identifier communication step in which said second communication device sends, via its second communication unit, an identifier, which identifier is received by said first communication device via its second communication unit, said identifier being used for identifying said second communication device, and wherein said first communication device approves or rejects communications which said second communication device executes with said first communication device, using said identifier.

Preferably, said method may further comprise an identifier communication step in which said first communication device sends, via its second communication unit, an identifier, which identifier is received by said second communication device via its second communication unit, said identifier being used for identifying said first communication device, and wherein said second communication device determines a range where said first communication device can use network resources in a wireless communication which said first communication device executes via its first communication unit, using said identifier.

Preferably, said method may further comprise an identifier communication step in which said second communication device sends, via its second communication unit, an identifier, which identifier is received by said first communication device via its second communication unit, said identifier being used for identifying said second communication device, and wherein said first communication device determines a range where said second communication device can use network resources in a wireless communication which said second communication device executes via its first communication unit, using said identifier.

In accordance with another aspect of the present invention, a communication device may comprise: a first communication unit for wireless communication; a second, different, communication unit; a storage unit, and; a control unit which sends guide information concerning communication forms usable by said first communication unit to other communication devices via said second communication unit.

In accordance with another aspect of the present invention, a communication device may comprise: a first communication unit for wireless communication; a second, different, communication unit; a storage unit, and; a control unit which receives, from a second, different, communication device of the same type as this device, via said second communication unit of this communication device, guide information concerning communication forms usable by said first communication unit of said second communication device, and which determines communication parameters for use when this communication device and said second communication device communicate via their respective first communication units.

In accordance with another aspect of the present invention, a record medium may contain a program and being readable by a computer, which computer controls a communication device, which communication device has a first communication unit for wireless communication, a second, different, communication unit, and a storage unit, and said program letting said computer;

detect that this communication device becomes communicable with other communication devices, via said second communication unit, and; send guide information concerning communication forms usable by said first communication unit, via said second communication unit, to said other communication devices.

In accordance with another aspect of the present invention, a record medium may contain a program and being readable by a computer, which computer controls a communication device, which communication device has a first communication unit for wireless communication, a second, different, communication unit, and a storage unit, and said program letting said computer;

detect that this communication device becomes communicable with other communication devices, via said second communication unit; receive from a second, different, communication device of the same type as this communication device, via said second communication unit of this communication device, guide information concerning communication forms usable by said first communication unit of said second communication device, and;

determine communication parameters for use when this communication device and said second communication device communicate via their respective first communication units.

In accordance with another aspect of the present invention, a program may let a computer, which computer controls a communication device, which communication device has a first communication unit for wireless communication, a second, different, communication unit, and a storage unit; detect that this communication device becomes communicable with other communication devices, via said second communication unit, and; send guide information concerning communication forms usable by said first communication unit, via said second communication unit, to said other communication devices.

In accordance with another aspect of the present invention, a program may let a computer, which computer controls a communication device, which communication device has a first communication unit for wireless communication, a second, different, communication unit, and a storage unit; detect that this communication device becomes communicable with other communication devices, via said second communication unit; receive from a second, different, communication device of the same type as this communication device, via said second communication unit of this communication device, guide information concerning communication forms usable by said first communication unit of said second communication device, and; determine communication parameters for use when this communication device and said second communication device communicate via their respective first communication units.

### BRIEF DESCRIPTION OF THE DRAWINGS

FIG. 1 is a diagram showing the general configuration of the wireless LAN system in the first embodiment of the present invention.

FIG. 2 is a diagram showing the general configuration of the mobile communication terminal in the first embodiment of the present invention.

FIG. 3 is a table showing the configuration of the protocol information file of the mobile communication terminal in the first embodiment of the present invention.

FIG. 4 is a table showing the configuration of the cryptograph key information file of the mobile communication terminal in the first embodiment of the present invention.

FIG. 5 is a table showing the configuration of the terminal information file of the mobile communication terminal in the first embodiment of the present invention.

FIG. 6 is a flowchart of the setting operation for wireless communication in the first embodiment of the present invention.

FIG. 7 is a diagram showing the general configuration of the wireless LAN system in the second embodiment of the present invention.

FIG. 8 is a diagram showing the general configuration of the communication terminal in the second embodiment of the present invention.

FIG. 9 is a table showing the configuration of the setting management information file of the communication terminal in the second embodiment of the present invention.

FIG. 10 is a table showing the configuration of the terminal information file of the communication terminal in the second embodiment and the communication terminal with a cable communication unit in the third embodiment of the present invention.

FIG. 11 is a table showing the configuration of the own protocol information file of the communication terminal in the second embodiment, the newly connecting communication terminal in the fourth embodiment, and the access point in the fourth embodiment of the present invention.

FIG. 12 is a table showing the configuration of the partner's protocol information file of the communication terminal in the second embodiment, the communication terminal with a cable communication unit in the third embodiment, the newly connecting communication terminal in the fourth embodiment, and the access point in the fourth embodiment of the present invention.

FIG. 13 is a table showing the configuration of the determined protocol information file of the communication terminal in the second embodiment and the newly connecting communication terminal in the fourth embodiment of the present invention.

FIG. 14 is a flowchart of the connection authentication stage in the setting operation for wireless communication in the second embodiment of the present invention.

FIG. 15 is a flowchart of the master/slave determination stage in the setting operation for wireless communication in the second embodiment of the present invention.

FIG. 16 and FIG. 17 are flowcharts of the parameter setting stage in the setting operation for wireless communication in the second embodiment of the present invention.

FIG. 18 is a diagram showing the general configuration of the wireless LAN system in the third embodiment of the present invention.

FIG. 19 is a diagram showing the general configuration of the communication terminal with a cable communication unit in the third embodiment of the present invention.

FIG. 20 is a table showing the configuration of the setting management Information File of the communication terminal with a cable communication unit in the third embodiment of the present invention.

FIG. 21 is a table showing the configuration of the own protocol information file of the communication terminal with a cable communication unit in the third embodiment of the present invention.

FIG. 22 is a table showing the configuration of the determined protocol information file of the communication terminal with a cable communication unit in the third embodiment of the present invention.

FIG. 23 is a table showing the configuration of the identifier information file of the communication terminals with a cable communication unit and without a cable communication unit in the third embodiment, and the access point in the fourth embodiment of the present invention.

FIG. 24 is a table showing the configuration of the public key information file of the communication terminals with a cable communication unit and without a cable communication unit in the third embodiment of the present invention.

FIG. 25 is a diagram showing the general configuration of the communication terminal without a cable communication unit in the third embodiment of the present invention.

FIG. 26 is a table showing the configuration of the setting management information file of the communication terminal without a cable communication unit in the third embodiment of the present invention.

FIG. 27 is a flowchart of the connection authentication stage in the setting operation for wireless communication in the third embodiment of the present invention.

FIG. 28 is a flowchart of the parameter setting stage in the setting operation for wireless communication in the third embodiment of the present invention.

FIG. 29, FIG. 30, FIG. 31, and FIG. 32 are flowcharts of the communication method after the setting operation for wireless communication in the third embodiment of the present invention.

FIG. 33 is a diagram showing the general configuration of the wireless LAN system in the fourth embodiment of the present invention.

FIG. 34 is a diagram showing the general configuration of the newly connecting communication terminal in the fourth embodiment of the present invention.

FIG. 35 is a table showing the configuration of the setting management information file of the newly connecting communication terminal in the fourth embodiment of the present invention.

FIG. 36 is a diagram showing the general configuration of the access point in the fourth embodiment of the present invention.

FIG. 37 is a table showing the configuration of the setting management information file of the access point in the fourth embodiment of the present invention.

FIG. 38 is a table showing the configuration of the access right information file of the access point in the fourth embodiment of the present invention.

FIG. 39 is a table showing the configuration of the common key information file of the access point in the fourth embodiment of the present invention.

FIG. 40 is a diagram showing the general configuration of the communication terminal which is not the newly connecting communication terminal in the fourth embodiment of the present invention.

FIG. 41 is a table showing the configuration of the setting management information file of the communication terminal which is not the newly connecting communication terminal in the fourth embodiment of the present invention.

FIG. 42, FIG. 43, and FIG. 44 are flowcharts of the connection authentication and parameter setting stage in the setting operation for wireless communication in the fourth embodiment of the present invention.

FIG. 45 and FIG. 46 are flowcharts of the communication method after the setting operation for wireless communication in the fourth embodiment of the present invention.

### DETAILED DESCRIPTION

Following are detailed descriptions of the preferred embodiments of the present invention. It will be readily understandable to those skilled in the art that the present invention is open to a variety of modifications, and the following embodiments are mere examples which should not in any way be interpreted as limiting the scope of the invention.

[1] The First Embodiment

[1.1] Configuration of the First Embodiment

[1.1.1] Configuration of the Wireless LAN System

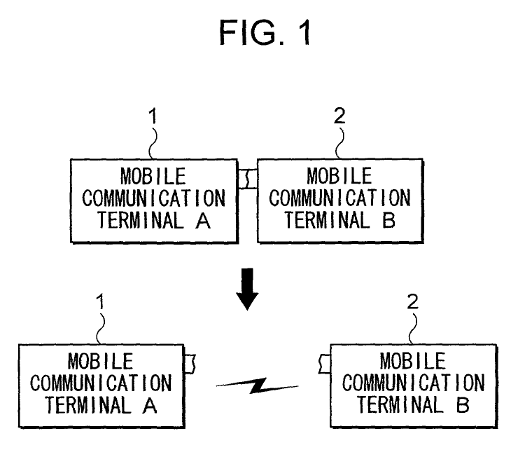

In the first embodiment the communication parameter setting method of the present invention is used to enable one-to-one communication between mobile communication terminals. FIG. 1 shows states of the wireless LAN system during a communication parameter setting stage and after parameter setting is complete. The wireless LAN system in the latter state in the first embodiment will hereafter be referred to as “wireless LAN system 1”. Wireless LAN system 1 is composed of mobile communication terminal A 1 and mobile communication terminal B 2.

[1.1.2] Configuration of Mobile Communication Terminal

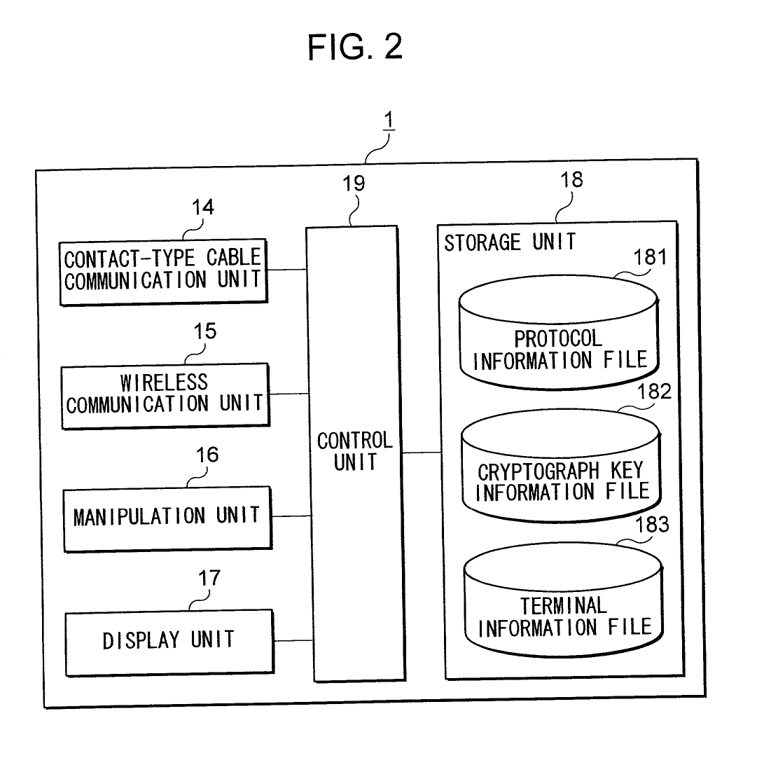

FIG. 2 shows the configuration of mobile communication terminal A 1 in the first embodiment of the present invention. The configuration of mobile communication terminal B 2 is the same as that of mobile communication terminal A 1, and for the sake of simplicity explanation is omitted of the configuration of mobile communication terminal B 2.

Mobile communication terminal A 1 has contact-type cable communication unit 14, wireless communication unit 15, manipulation unit 16, display unit 17, and storage unit 18, and control unit 19 connected to each of these components.

In establishing an electric connection, contact-type cable communication unit 14 is brought into direct contact with a communication unit of the same type, whereby electric signals which contain parameter information and so on are sent and received under control of control unit 19. Communication devices which have the same kind of communication unit as contact-type cable communication unit 14 share a single communication protocol, and mobile communication terminal A 1 sends and receives information through contact-type cable communication unit 14 by way of the communication protocol.

Wireless communication unit 15 has an antenna (not shown), and it demodulates received signals into base band signals, which signals contain text and picture data, and so on, and are sent via the antenna to control unit 19. Wireless communication unit 15 also receives base band signals from control unit 19, and the resulting carrier signals are modulated on the basis of the base band signals, and sent via the antenna to the outside. Wireless communication unit 15 has a nonvolatile memory (not shown) to store communication parameters. When wireless communication unit 15 performs wireless communication explained above, it chooses a channel Identifier (ID), a Personal Identification Number (PIN) code, and so on, on the basis of communication parameters stored in its nonvolatile memory. Wireless communication unit 15 is able to use several kinds of wireless communication protocols; so several Media Access Control (MAC) addresses are allocated to wireless communication unit 15 for each of the wireless communication protocols. Different protocols are used in wireless communication unit 15 under the control of control unit 19.

Manipulation unit 16 has a keypad (not shown), and when the user manipulates the keypad, it sends the signals to control unit 19 corresponding to the keys manipulated.

Display unit 17 has a liquid crystal display (not shown), a drive circuit for the display (not shown), and a video Random Access Memory (RAM) (not shown). Display unit 17 converts text, pictures, and so on, into bitmap data, and writes the bitmap data in the video RAM. The drive circuit reads out data for a screen image in the video RAM at regular intervals, and on the basis of the data refreshes color and brightness properties of the liquid crystal display.

Storage unit 18 stores a protocol information file 181, a cryptograph key information file 182, and a terminal information file 183.

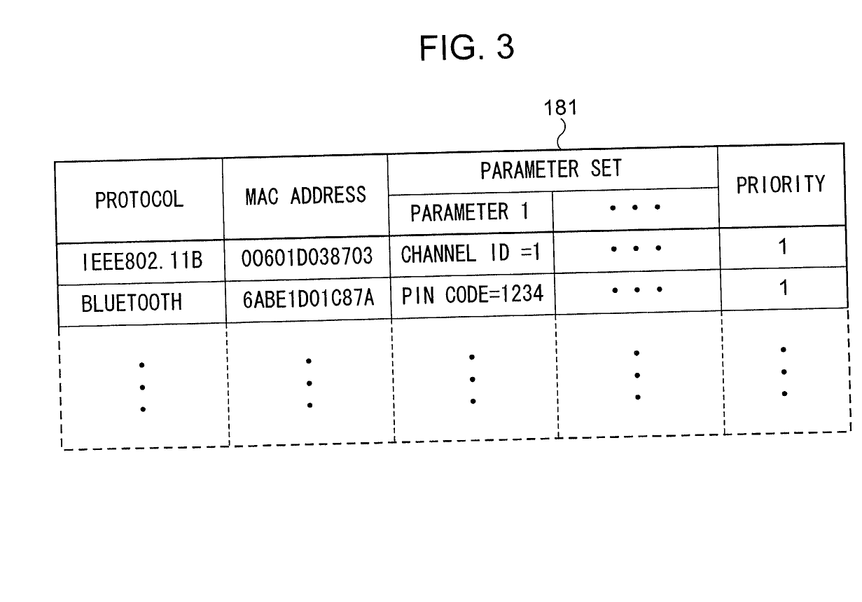

FIG. 3 shows the configuration of protocol information file 181. Protocol information file 181 contains records on wireless communication protocols usable in mobile communication terminal A 1. Each record comprises a set of information of one of the wireless communication protocols usable in mobile communication terminal A 1, and has a protocol field, a MAC address field, a parameter set field, and a priority field.

The protocol field contains the name of the target protocol. IEEE802.11b, Bluetooth, and Infrared Data Association (IrDA) are examples of information to be stored in the field.

The MAC address field contains the MAC address which is used when mobile communication terminal A 1 communicates with other terminals using the target protocol.

The parameter set field has several child fields named parameter 1, parameter 2, and so on, and each child field contains one of the parameters for the target protocol. Channel ID of IEEE802.11b and PIN code of Bluetooth are examples of types of information stored in the field.

The priority field contains a positive integer which expresses the priority of the target protocol among all protocols usable in mobile communication terminal A 1. If the target protocol has a smaller integer, its use is preferential.

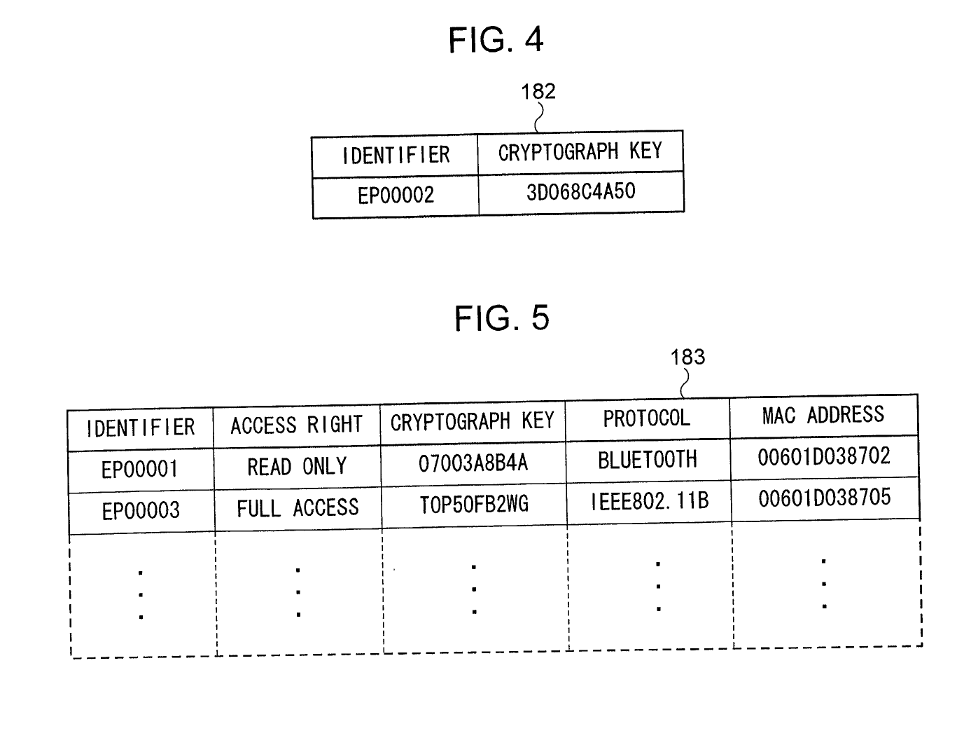

FIG. 4 shows the configuration of cryptograph key information file 182. Cryptograph key information file 182 has an identifier item and a cryptograph key item. The identifier item contains an identifier which is allocated to mobile communication terminal A 1 to distinguish mobile communication terminal A 1 from other terminals. Identifiers are combinations of figures and letters, and each identifier is unique. The cryptograph key item contains information of a cryptograph key by which mobile communication terminal A 1 encrypts information when mobile communication terminal A 1 sends information to other terminals in wireless LAN system 1.

FIG. 5 shows the configuration of terminal information file 183. Terminal information file 183 is the file for holding information of terminals to which mobile communication terminal A 1 has previously been connected in one-to-one communication according to the first embodiment of the present invention. Terminal information file 183 contains on records on terminals to which mobile communication terminal A 1 has previously been connected. Each record has an identifier field, an access right field, a cryptograph key field, a protocol field, and a MAC address field.

The identifier field contains the identifiers of partner terminals connected to in one-to-one communication.

The access right field contains information on access rights which provided to the partner terminals when they use network resources of mobile communication terminal A 1. Read Only and Full Access are examples of kinds of access right. In the case that the value of the access right field of one record shows Read Only, when the terminal to which the record corresponds uses any shared network resources of mobile communication terminal A 1, the terminal is permitted only to refer to information in those resources. While, in the case that the value of the access right field of one record shows Full Access, when the terminal to which the record corresponds uses any shared network resources of mobile communication terminal A 1, the terminal is permitted to refer to, edit, and delete information in the resources.

The cryptograph key field contains information of cryptograph keys by which mobile communication terminal A 1 decodes information when mobile communication terminal A 1 receives information from its partner terminals.

The protocol field contains names of protocols by which mobile communication terminal A 1 executes wireless communication with its partner terminals.

The MAC address field contains MAC addresses of the partner terminals which are used when mobile communication terminal A 1 executes wireless communication with its partner terminals.

Control unit 19 has a nonvolatile memory (not shown) to record program software for controlling mobile communication terminal A 1. When an instruction is made by the program software, control unit 19 controls the other components of mobile communication terminal A 1 on the basis of information it receives from the other components.

[1.2] Operation of the First Embodiment

[1.2.1] Communication Parameter Setting Stage

Following is an explanation of wireless communication parameter setting operations according to the first embodiment of the present invention.

In the following operation, mobile communication terminal A 1 sends a connection request to mobile communication terminal B 2. After this, if it is necessary to distinguish like type components of mobile communication terminal A 1 and mobile communication terminal B 2, the letters “A” and “B” are respectively provided after the numbers which are assigned to the components and used to distinguish them. Also, in the following operation, all communication between mobile communication terminal A 1 and mobile communication terminal B 2 is carried out through contact-type cable communication unit 14A and contact-type cable communication unit 14B.

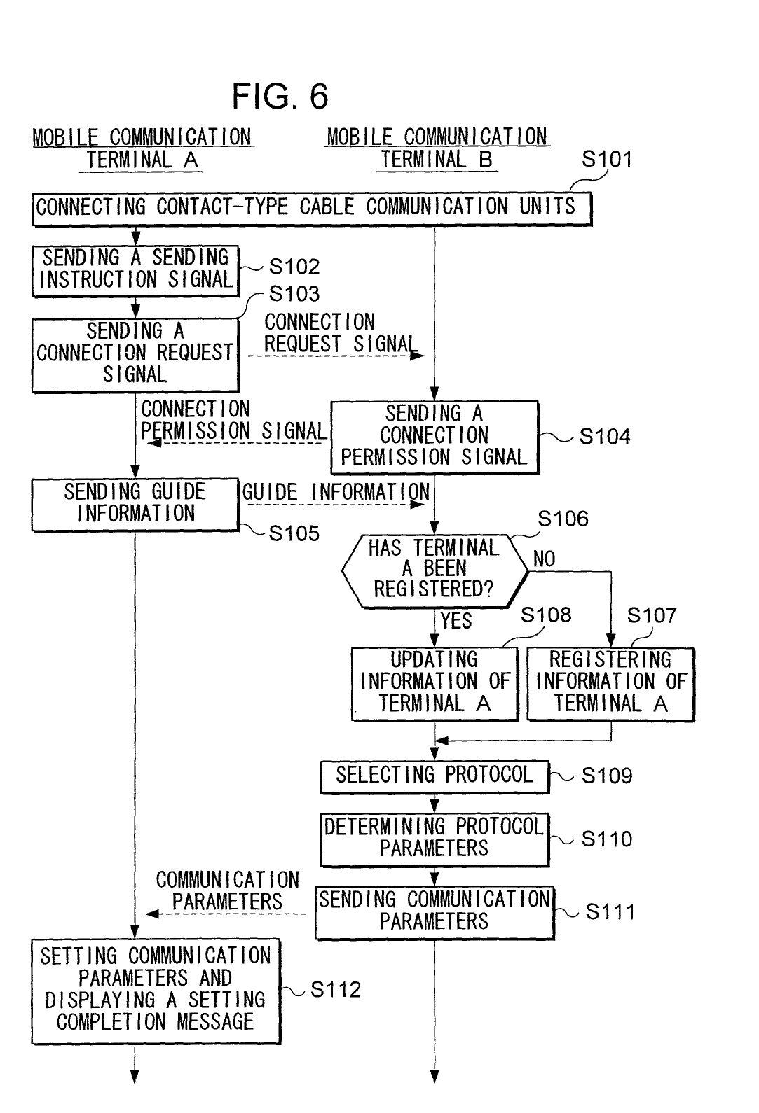

First, a user of mobile communication terminal A 1 or mobile communication terminal B 2 directly connects contact-type cable communication unit 14A and contact-type cable communication unit 14B (FIG. 6, Step S101).

Next, the user inputs a sending instruction by manipulation unit 16A of mobile communication terminal A 1. Manipulation unit 16A sends a sending instruction signal to control unit 19A (Step S102). Control unit 19A receives the signal, and sends a connection request signal to mobile communication terminal B 2 (Step S103).

Control unit 19B of mobile communication terminal B 2 receives the connection request signal. Next, control unit 19B sends a connection permission signal, which informs the other terminal that mobile communication terminal B 2 can accept the request of connection, to mobile communication terminal A 1 (Step S104).

Control unit 19A of mobile communication terminal A 1 receives the connection permission signal. Then, control unit 19A reads out protocol information file 181A and cryptograph key information file 182A, and prepares information as guide information for determination of communication parameters as follows:

Values of the protocol field and MAC address field of all records of protocol information file 181A (referred to as “Protocol Table A” hereafter);

the identifier item value of cryptograph key information file 182A (referred to as “ID-A” hereafter); and

the cryptograph key item value of cryptograph key information file 182A (referred to as “Key-A” hereafter).

After control unit 19A prepares the information above, it sends the information to mobile communication terminal B 2 (Step S105).

Control unit 19B of mobile communication terminal B 2 receives Protocol Table A, ID-A, and Key-A as guide information. Then, control unit 19B reads out terminal information file 183B, and judges if the identifier field of any record of terminal information file 183B has the same value as ID-A (Step S106). In the case that the identifier field of a record does not have the same value as ID-A, control unit 19B obtains “No” as a result of the judgment of Step S106. This means that mobile communication terminal A 1 has not been registered to mobile communication terminal B 2 yet. On the other hand, in the case that the identifier field of a record has the same value as ID-A, control unit 19B obtains “Yes” as a result of the judgment of Step S106. This means that mobile communication terminal A 1 has already been registered to mobile communication terminal B 2.

In the case that control unit 19B obtains “No” as the result of the judgment of Step S106, control unit 19B adds a new record to terminal information file 183B, and places ID-A in the identifier field of the record, “Read Only” in the access right field of the record, and Key-A in the cryptograph key field of the record (Step S107).

On the other hand, in the case that control unit 19B obtains “Yes” as a result of the judgment of Step S106, control unit 19B retrieves a record of the cryptograph key field value which is the same as ID-A in terminal information file 183B, and updates the identifier field value of the retrieved record with Key-A (Step S108).

After Step S107 or Step S108, control unit 19B reads out protocol information file 181B, and retrieves from the file those records which have a protocol field value which is the same as any protocol field value of any record of Protocol Table A, which it received from mobile communication terminal A 1 at Step S106. In the case that several records are retrieved from protocol information file 181B, control unit 19B compares priority field values of the records, and selects a record which has the lowest priority field value. In the case that only one record is retrieved from the file, control unit 19B selects that record. Then, control unit 19B obtains the protocol field value of the selected record (referred to as “Determined Protocol 1” hereafter) and the value of the MAC address field (referred to as “MAC-B” hereafter).

Then, control unit 19B retrieves from Protocol Table A, a record which has a protocol field value which is the same as Determined Protocol 1, and obtains the value of the MAC address field of the retrieved record (referred to as “MAC-A” hereafter). Next, control unit 19B reads out terminal information file 183B, and it retrieves from the file, a record which has an identifier field value which is the same as ID-A. Control unit 19B updates the protocol field value of the retrieved record with Determined Protocol 1, the MAC address field value of the record on the basis of MAC-A, respectively (Step S109).

Next, control unit 19B reads out protocol information file 181B, and it retrieves from the file a record which has a protocol field value which is the same as Determined Protocol 1. Then control unit 19B determines protocol parameters for mobile communication terminal A 1 on the basis of the parameter set field values of the retrieved record (Step S110). For example, if Determined Protocol 1 is “IEEE802.11b”, and the parameter set field of the record corresponding to “IEEE802.11b” contains “Channel ID=1”, control unit 19B determines “Channel ID=1” as one of the parameters of IEEE802.11b for mobile communication terminal A 1. Hereafter, protocol parameters determined at Step S110 will be referred to as “Determined Parameter Set 1”.

Next, control unit 19B reads out cryptograph key information file 182B, and obtains the identifier item value (referred to as “ID-B” hereafter) and the cryptograph key item value (referred to as “Key-B” hereafter). Then control unit 19B sends as communication parameters to mobile communication terminal A 1, ID-B, Key-B, Determined Protocol 1, MAC-B, and Determined Parameter Set 1 (Step S111).

When control unit 19A of mobile communication terminal A 1 receives ID-B, Key-B, Determined Protocol 1, MAC-B, and Determined Parameter Set 1 as communication parameters, it reads out terminal information file 183A, and it retrieves from the file a record which has an identifier field value which is the same as ID-B. Control unit 19A updates the value of the cryptograph key field of the retrieved record with Key-B, the value of the protocol field of the record on the basis of Determined Protocol 1, and the value of the MAC address field of the record on the basis of MAC-B, respectively. In the case that no record of terminal information file 183A has an identifier field value which is the same as ID-B, control unit 19A adds a new record to terminal information file 183A, and places ID-B in the identifier field of the record, “Read Only” in the access right field of the record, Key-B in the cryptograph key field of the record, Determined Protocol 1 in the protocol field, and MAC-B in the MAC address field, respectively. Then control unit 19A sends Determined Protocol 1 and Determined Parameter Set 1 to wireless communication unit 15A, and wireless communication unit 15A updates the protocol parameters of Determined Protocol 1 in its nonvolatile memory with Determined Parameter Set 1. Then, control unit 19A sets display unit 17A to display a message stating that wireless communication parameter setting is complete (Step S112).

[1.2.2] The Method of Communication using the Cryptograph Key

In the case that mobile communication terminal A 1 sends information to mobile communication terminal B 2 after the communication parameter setting stage explained above, first, control unit 19A reads out cryptograph key information file 182A, and encrypts the information, which it is sending to mobile communication terminal B 2, using the value of the cryptograph key field, namely Key-A. Then control unit 19A reads out terminal information file 183A, retrieves from the file a record which has a MAC address field value which is the same as the MAC address of the receiver of the information, namely MAC-B, and formats the encrypted information using the communication protocol selected on the basis of the protocol field value of the retrieved record. Then control unit 19A adds MAC-B as information of the receiver and MAC-A as information of the sender to the formatted information, and sends it to mobile communication terminal B 2 through wireless communication unit 15A.

In the case that mobile communication terminal A 1 receives encrypted information from mobile communication terminal B 2 after the communication parameter setting stage, first, control unit 19A obtains the MAC address of the sender, namely MAC-B, from the information which it receives. Then control unit 19A reads out terminal information file 183A, retrieves from the file, a record which has a MAC address field value which is the same as MAC-B, and decodes the information, which it received from mobile communication terminal B 2, using the value of the cryptograph key field, namely Key-B. In the case that the decoded information contains information that mobile communication terminal B 2 is requesting mobile communication terminal A 1 to approve mobile communication terminal B 2 to use the network resources of mobile communication terminal A 1, control unit 19A approves or rejects the request on the basis of the value of the access right field of the retrieved record of terminal information file 183A.

[1.3] Advantages of the First Embodiment

In the first embodiment, when it is desired to effect communication between two mobile communication terminals using a wireless LAN system, necessary communication information such as information on the mobile communication terminals such as identifiers, parameters for wireless communication protocols, cryptograph keys, and so on, are set in the terminals at the time when they are just directly connected to each other via their contact-type cable communication units. Therefore, the users of the mobile communication terminals can start wireless communication easily even if they do not have expertise of network technology.

In the first embodiment, a wireless communication protocol, which is used in wireless LAN system 1, is selected on the basis of priorities which were set for all available wireless communication protocols in advance. Therefore, users of the mobile communication terminals can readily use a presently suitable wireless communication protocol, without the need for any technical knowledge of such protocols.

In wireless LAN system 1, according to the first embodiment of the present invention, information exchanged between mobile communication terminals is encrypted, and therefore protected from unauthorized access.

[1.4] Selected Modifications of the First Embodiment

In the first embodiment, the communication device, which determines communication parameters necessary for wireless communication, is the same kind of mobile communication terminal as the other device, which does not determine the communication parameters. However, the device which determines the communication parameters is not necessarily such a terminal, and for example, it can be an access point which relays information from one wireless communication device to another. In such a case, the mobile communication terminal, which is newly connected to the wireless system, can communicate with communication devices which are connected to the access point, after it completes the parameter setting of the present invention.

In the first embodiment, users of the mobile communication terminals establish the connection between the terminals via their contact-type cable communication units directly, and the mobile communication terminals send and receive the information necessary for the wireless communication in wireless LAN system 1. However, direct contact need not necessarily be used for establishing a connection; a user may, for example, connect cable communication units of terminals via data communication cables.

Moreover, wireless communication units can be used for sending and receiving information for wireless communication in wireless LAN system 1, rather than using contact-type cable communication units. In such a case, one wireless communication protocol, for communication parameter setting, is installed in each mobile communication terminals, which need to communicate with each other, in advance, and the terminals execute the communication parameter setting for the wireless communication protocol, which is used in wireless LAN system 1, using the protocol for the communication parameter setting. In this way, users can avoid connecting terminals directly or with cables, and can more easily execute communication parameter setting for the wireless communication.

In the first embodiment, a connection request signal is sent in response to a sending instruction made by a user to his or her terminal. However, it is to be noted that the way in which a connection request signal is sent, is not limited to an instruction made by the user. For example, the control unit of a mobile communication terminal may send a connection request signal to another terminal in response to a trigger signal given by its timer once a predetermined period of time has passed following connection of contact-type cable communication units to each other.

In the first embodiment, original identifiers for wireless LAN system 1 are allocated to each of mobile communication terminal. However, such identifiers need not necessarily be original. For example, MAC addresses can be used as identifiers. Since a communication device is given its own MAC address, it is not necessary for an administrator to allocate identifiers to every mobile communication terminal used in the system.

In the first embodiment, messages informing completion of communication parameter setting for wireless communication are displayed in the display units. However, there can be conceived other ways of informing completion of this operation. For example, the mobile communication terminals can be provided with audio output units, whereby the control units can audibly inform completion of communication parameter setting.

The control units of the mobile communication terminals need not necessarily be preinstalled with program software to execute control operations of the first embodiment. For example, mobile communication terminals can be provided with data reading units, and their control units can be configured to read the program software from external storage media by way of the data-reading units, and to execute an externally stored program. Furthermore, the mobile communication terminals can be provided with communication units to access through telecommunication lines data stored in external storage devices, and the control units can be configured to download the program software by way of the communication units, and to execute software program in the software.

In wireless LAN system 1, according to the first embodiment of the present invention, common cryptograph keys are used to encrypt information, but other forms of encryption can also be used. One example would be for the control units to encrypt information using a public key system.

[2] The Second Embodiment

[2.1] The Configuration of the Second Embodiment

[2.1.1] The Configuration of the Wireless LAN System

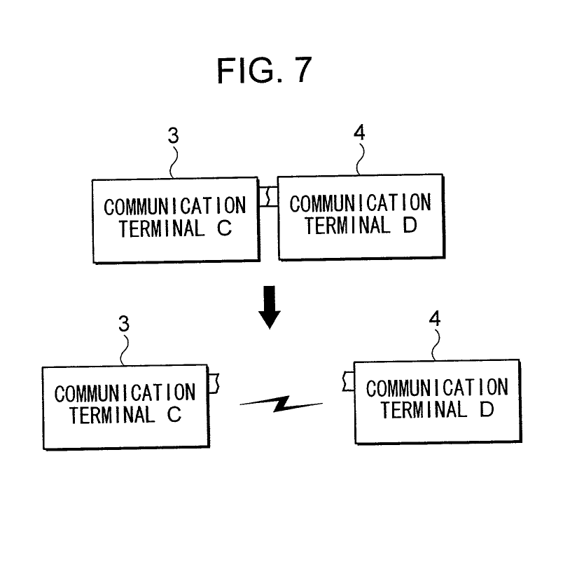

In the second embodiment of the present invention, similar to the first embodiment, one-to-one communication is enabled between two communication terminals using the communication parameter setting method of the present invention. FIG. 7 shows a state of the wireless LAN system in the communication parameter setting stage and a state after communication parameter setting in the second embodiment is complete. Hereafter, the LAN system in a state in which communication parameter setting has been completed in accordance with the second embodiment of the present invention will be referred to as “wireless LAN system 2”. Wireless LAN system 2 is composed of a communication terminal C 3 and a communication terminal D 4.

In the first embodiment, in order to determine which communication terminal will request communication parameters for wireless communication and which will determine communication parameters, it is necessary for a user of one of the communication terminals to provide to his/her communication terminal using its manipulation unit an instruction to start a parameter setting operation. However, in the second embodiment, there is no need for the user to provide such an instruction. Specifically, the communication terminals are configured to be able to automatically request or determine, as required, parameter settings in a communication parameter setting stage. Hereafter, a communication terminal which determines communication parameters will be referred to as “a master terminal” and the other of the communicating terminals will be referred to as “a slave terminal”. When a master terminal determines suitable communication parameters for communication with a slave terminal in wireless LAN system 2, it changes its own communication parameters to those determined to be suitable and sends them to the slave terminal. When the slave terminal receives the communication parameters it changes its own communication parameters to those sent by the master terminal.

Moreover, in the first embodiment, only parameters related to wireless communication protocols in lower layers, such as IEEE802.11b, etc. are handled, whereas in the second embodiment, parameters related to communication protocols in middle layers, such as TCP/IP, and so on, are also set.

[2.1.2] The Configuration of the Communication Terminal

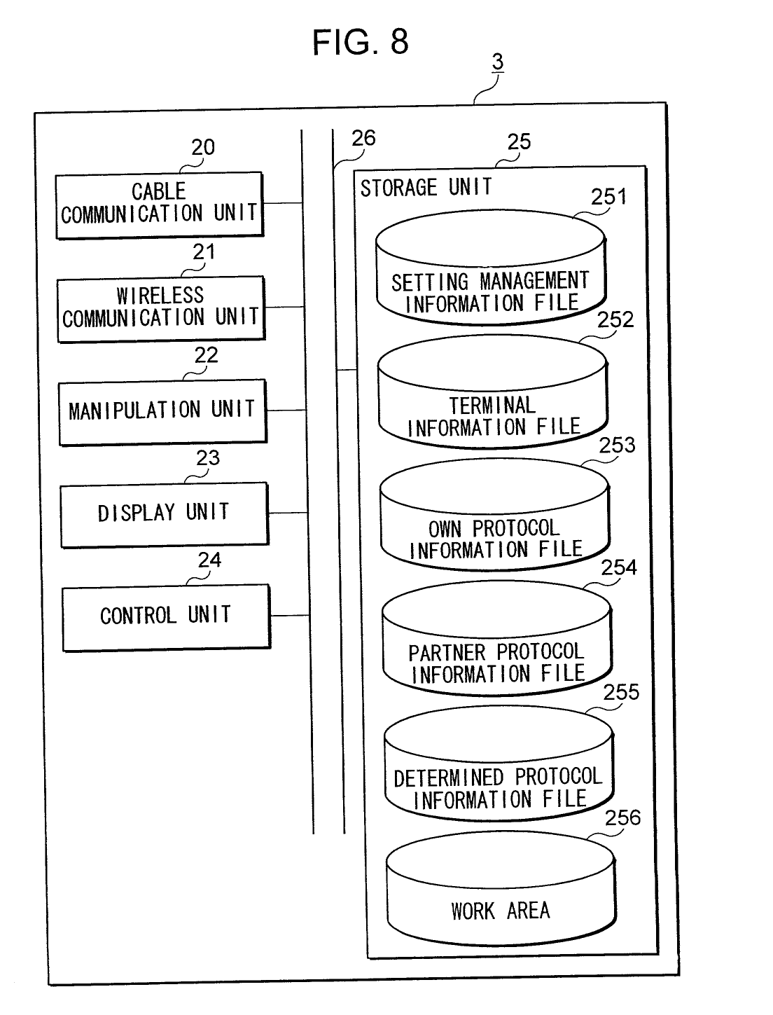

FIG. 8 shows the configuration of communication terminal C 3. The configuration of communication terminal D 4 is the same as that of communication terminal C 3, and thus explanation of the configuration of communication terminal D 4 is omitted.

Communication terminal C 3 has a cable communication unit 20, a wireless communication unit 21, a manipulation unit 22, a display unit 23, a control unit 24, and a storage unit 25. All of these components are electrically connected to each other through a bus 26.

The functions and the configurations of cable communication unit 20, wireless communication unit 21, manipulation unit 22, display unit 23, and control unit 24 are the same as those of contact-type cable communication unit 14, wireless communication unit 15, manipulation unit 16, display unit 17, and control unit 19 of mobile communication terminal A 1 in the first embodiment, respectively, and explanation of the units is therefore omitted. The function of storage unit 25 is also the same as that of storage unit 18 of mobile communication terminal A 1 in the first embodiment, and explanation is therefore also omitted.

Storage unit 25 stores a setting management information file 251, a terminal information file 252, an own protocol information file 253, a partner protocol information file 254, and a determined protocol information file 255, and has a work area 256.

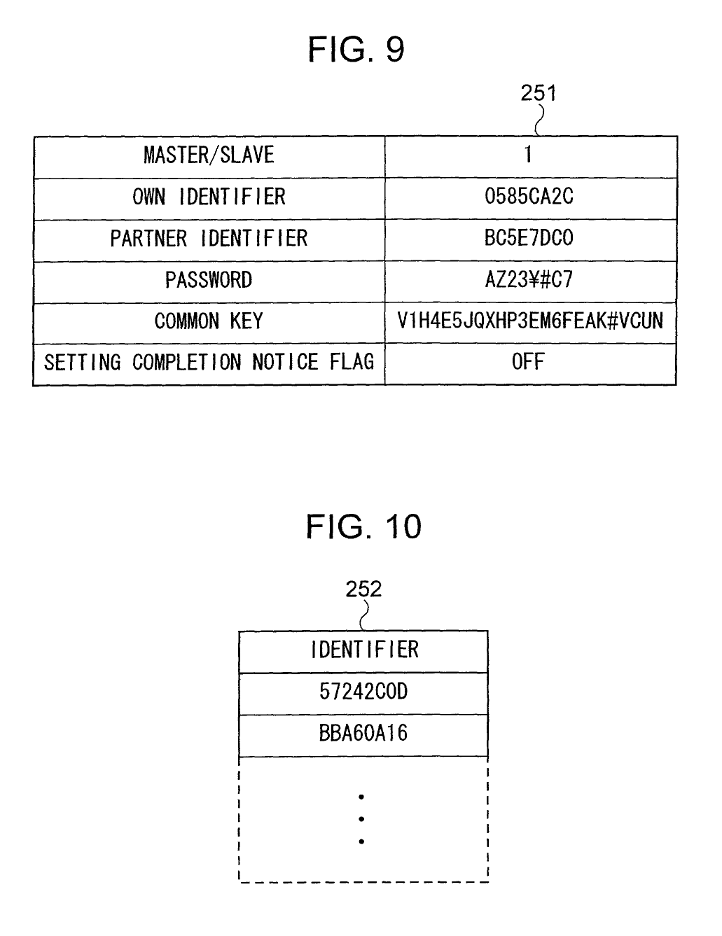

FIG. 9 shows the configuration of setting management information file 251. Setting management information file 251 has a master/slave item, an own identifier item, a partner identifier item, a password item, a common key item, and a setting completion notice flag item. The master/slave item is used for determining whether communication terminal C 3 should function as a master terminal or a slave terminal in the communication parameter setting for wireless LAN system 2, and “0”, “1”, or “2” is set. “0” means setting has not been performed yet, “1” means communication terminal C 3 has been set as a master terminal, and “2” means communication terminal C 3 has been set as a slave terminal. The own identifier item contains an identifier to distinguish communication terminal C 3 from other terminals, and the identifier is not changed. Identifiers are combinations of figures and letters. The partner identifier item contains an identifier of a partner communication terminal with which communication terminal C 3 communicates in wireless LAN system 2. The password item contains a password which is used for preventing unauthorized access to communication terminal C 3. The common key item contains information on a cryptograph key by use of which communication terminal C 3 encrypts and decodes information when communication terminal C 3 communicates with other communication terminals in wireless LAN system 2. The setting completion notice flag item is used to verify that a partner communication terminal of communication terminal C 3 in wireless LAN system 2 completes its wireless communication parameter setting. This is performed by using an indicator “OFF” or “ON”, where “OFF” means the setting is not completed and “ON” means the setting is completed.

FIG. 10 shows the configuration of terminal information file 252. Terminal information file 252 contains records on communication terminals which have previously been connected to communication terminal C 3. Each record of terminal information file 252 has an identifier field, which contains identifier of the target communication terminal.

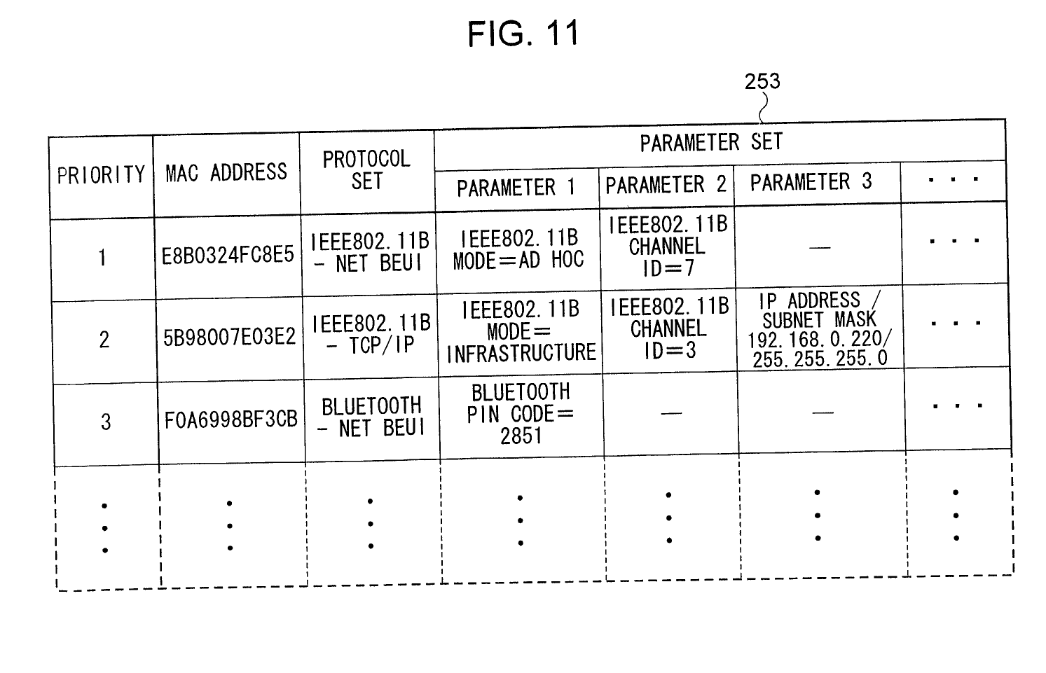

FIG. 11 shows the configuration of own protocol information file 253. Own protocol information file 253 is a file composed of information on a set of communication protocols which communication terminal C 3 can use. Hereafter, a “protocol set”, is used to mean a combination of a protocol of a lower layer and a protocol of a middle layer; for example, “IEEE802.11b TCP/IP” and “Bluetooth NetBEUI”. The number of records of own protocol information file 253 is the same as that of communication protocol sets which communication terminal C 3 can use. Each record consists of an aggregation of information on one communication protocol set, and contains a priority field, a MAC address field, and a parameter set field. The priority field contains a positive integer, and the smaller the integer, the higher the priority of the target protocol set. A user or an administrator sets the integer in advance. The MAC address field contains a MAC address which is allocated to the target communication protocol set. The parameter set field has several child fields named parameter 1, parameter 2, and so on, and each child field contains one of parameters for the target communication protocol set. Each communication protocol set has a different number of parameters, and the parameter set field has a sufficient number of child fields to contain parameters of any communication protocol set.

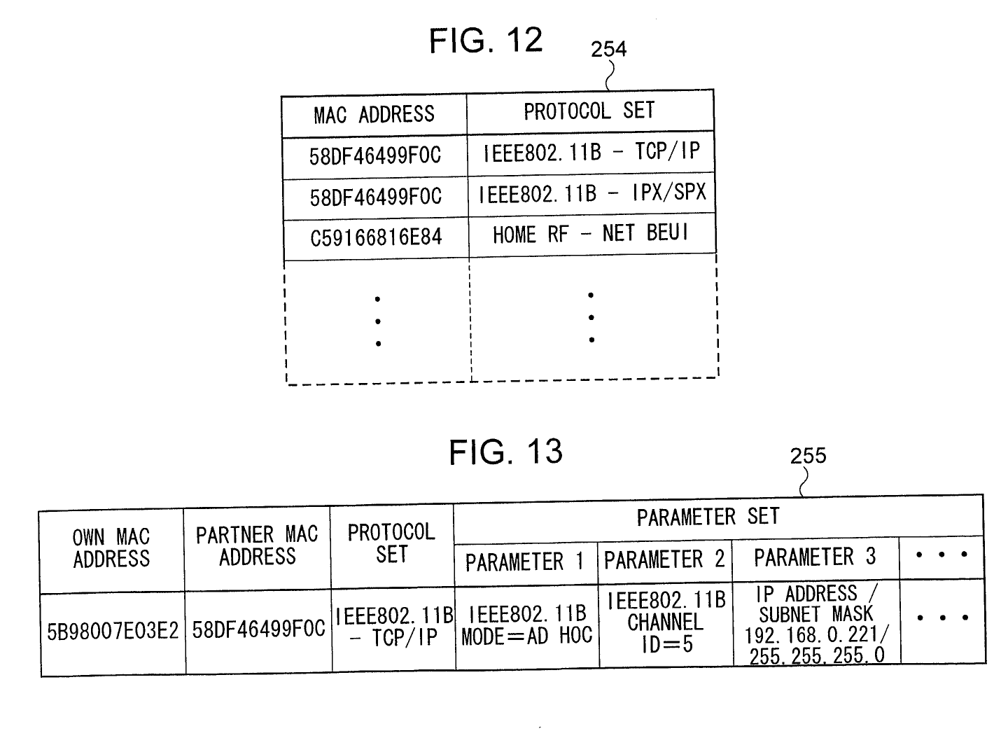

FIG. 12 shows the configuration of partner protocol information file 254. Partner protocol information file 254 contains information on communication protocol sets which can be used by the partner communication terminal, which is connected to communication terminal C 3 in wireless LAN system 2. The number of records of partner protocol information file 254 is the same as that of the communication protocol sets usable by the partner communication terminal. Each record consists of an aggregation of information about one communication protocol set, and comprises a MAC address field and a protocol set field. The MAC Address field contains a MAC address which is allocated to a target communication protocol set. The protocol set field contains information showing the name of the target communication protocol set.

FIG. 13 shows the configuration of determined protocol information file 255. Determined protocol information file 255 contains information on a communication protocol set which is used in wireless LAN system 2. Determined protocol information file 255 is composed of one record, and the record contains an own MAC address field, a partner MAC address field, a protocol set field, and a parameter set field. The own MAC address field contains MAC address of communication terminal C 3 which communication terminal C 3 uses when it communicates with the partner communication terminal using a target communication protocol set. The partner MAC address field contains MAC address of the partner communication terminal which the partner communication terminal uses when it communicates with communication terminal C 3 using a target communication protocol set. The protocol set field contains information showing name of a target communication protocol set. The parameter set field has several child fields named parameter 1, parameter 2, and so on, and each of the child fields contains one of parameters for a target communication protocol set.

Work Area 256 is an area in which control unit 24 temporarily stores programs and data when it executes its control processes.

[2.2] Operation of the Second Embodiment

The communication parameter setting operation for wireless LAN system 2 in the second embodiment, and the communication operation performed after the communication parameter setting will now be described. The communication parameter setting consists of a connection authentication stage, a master/slave determination stage, and a parameter setting stage. Following is an example of operations performed to enable one-to-one wireless communication between communication terminal C 3 and communication terminal D 4. Hereafter, to distinguish like components of communication terminal C 3 and communication terminal D 4, the letters “C” and “D” are placed after respective numerals which denote like corresponding components.

In the following operation of the connection authentication stage, the master/slave determination stage, and the parameter setting stage, cable communication unit 20C and cable communication unit 20D are used for all communication between communication terminal C 3 and communication terminal D 4.

[2.2.1] Connection Authentication Stage

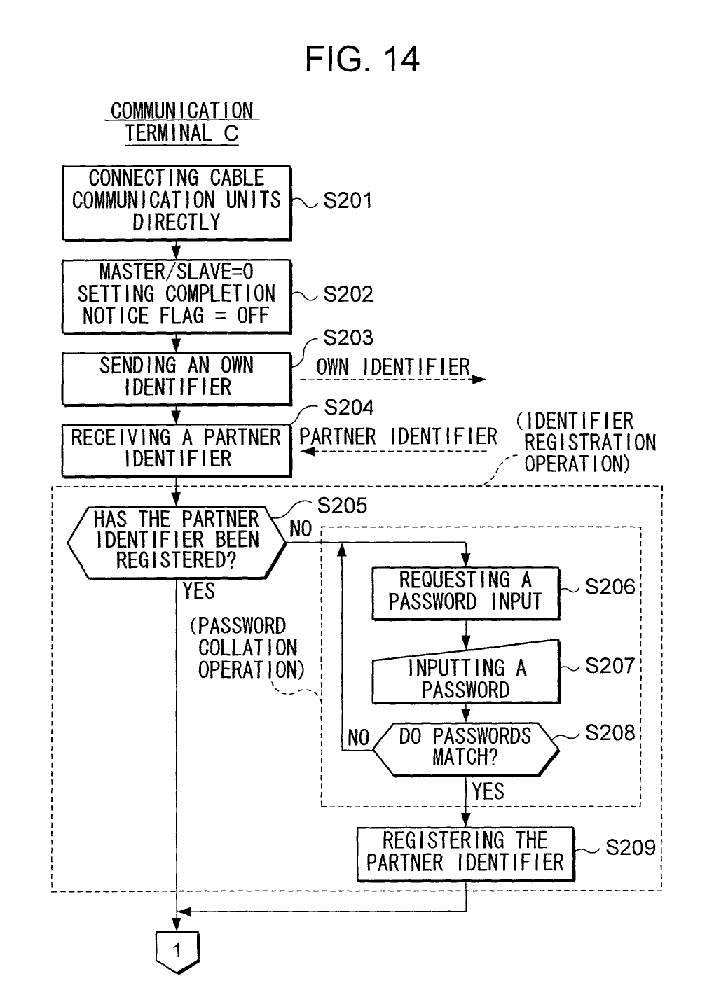

First, communication terminal C 3 and communication terminal D 4 authenticate their partner communication terminals. As shown in FIG. 14, this operation is performed simultaneously in communication terminal C 3 and communication terminal D 4 in the same way. Consequently, only the operation of communication terminal C 3 is described here. The operation of communication terminal D 4 is given by exchanging the signs “C” and First, a user of communication terminal C 3 or communication terminal D 4 directly connects cable communication unit 20C of communication terminal C 3 and cable communication unit 20D of communication terminal D 4 (FIG. 14, Step S201).

When control unit 24C detects through cable communication unit 20C a cable connection with another communication terminal, control unit 24C reads out setting management information file 251C, and puts “0” in the master/slave item of the file and “OFF” in the setting completion notice flag item of the file, respectively (Step S202).

Next, control unit 24C sends the own identifier item value of setting management information file 251 C (referred to as “ID-C” hereafter) to communication terminal D 4 (Step S203).

Similarly, communication terminal D 4 sends the own identifier item value of setting management information file 251D (referred to as “ID-D” hereafter) to communication terminal C 3. Control unit 24C receives ID-D and updates the partner identifier item value of setting management information file 251C with ID-D (Step S204).

Next, control unit 24C reads out terminal information file 252C, and judges if the identifier field of any record of the file has the same value as ID-D (Step S205). In the case that communication terminal C 3 has not previously authenticated the connection of communication terminal D 4, no identifier field of any record will have the same value as ID-D, and control unit 24C obtains “No” as a result of the judgment of Step S205. In the case that communication terminal C 3 has previously authenticated the connection of communication terminal D 4, an identifier field of one of the records will have the same value as ID-D, and control unit 24C obtains “Yes” as a result of the judgment of Step S205.

In the case that control unit 24C obtains “Yes” at Step S205, it moves to Step S210 explained below.

In the case that control unit 24C obtains “No” at Step S205, it displays a message to request password input by display unit 23C (Step S206). Password input is an operation to confirm that communication terminal C 3 newly authenticates the connection of communication terminal D 4 to communication terminal C 3.

After the user of communication terminal C 3 inputs a password (the value of this password is referred to as “Input Password C” hereafter) by manipulation unit 22C, and control unit 24C receives Input Password C (Step S207), Control unit 24C reads out setting management information file 251C, and judges if Input Password C has the same value as that of the password item of the file (referred to as “Registered Password” hereafter) (Step S208). In the case that Input Password C is different from Registered Password, control unit 24C obtains “No” as a result of the judgment of Step S208. In the case that Input Password C is the same as Registered Password, control unit 24C obtains “Yes” as a result of the judgment of Step S208.

In the case that control unit 24C obtains “No” at Step S208, it moves to Step 206, and the series of operations described in Step S206 to Step 208 is repeated until the two passwords match. Hereafter, the series of operations described in Step S206 to Step 208 will be referred to as “password collation operation”.

In the case that control unit 24C obtains “Yes” at Step S208, control unit 24C reads out terminal information file 252C, and adds a new record to the file, and places ID-D in the identifier field of the record (Step S209). By this operation, communication terminal D 4 is newly registered in communication terminal C 3. After Step S209, control unit 24C moves to Step S210. Hereafter, the series of operations described in Step S205 to Step 209 will be referred to as “identifier registration operation”.

[2.2.2] Master/Slave Determination Stage

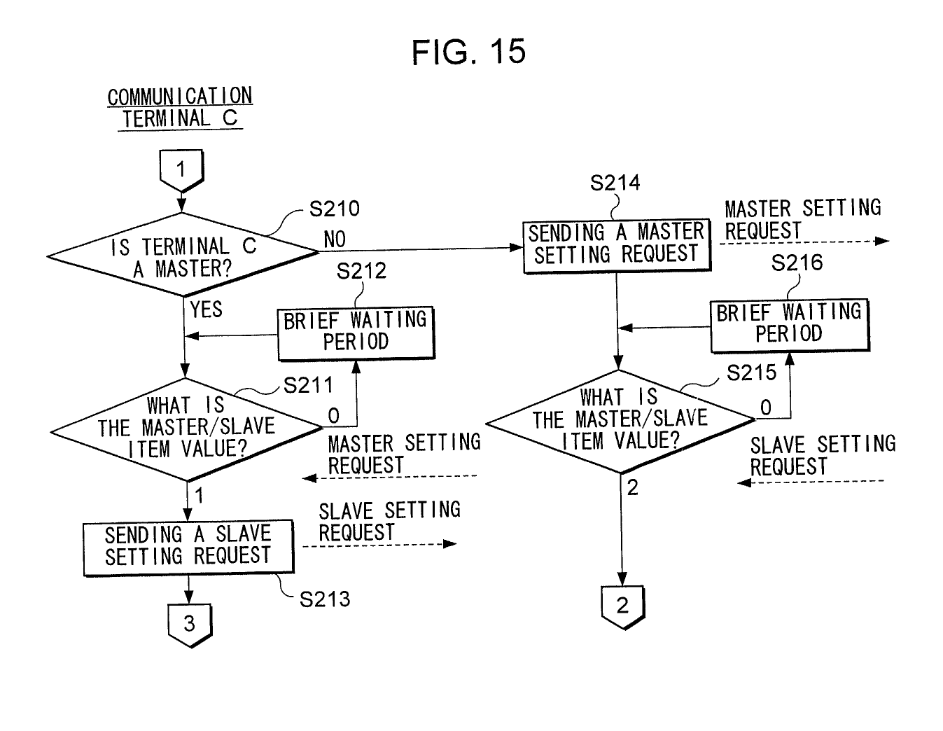

After completion of the connection authentication stage explained above, communication terminal C 3 and communication terminal D 4 determine which will function as a master terminal and which as a slave terminal. This operation is explained hereafter with reference to FIG. 15.

The following operation is performed simultaneously in communication terminal C 3 and communication terminal D 4 in the same way. Consequently, only operation of communication terminal C 3 is explained. Operation of communication terminal D 4 can be understood by simply interchanging the signs “C” and “D” used in the explanation relating to communication terminal C 3.

After control unit 24C completes authentication of communication terminal D 4, it reads out setting management information file 251 C, and judges if communication terminal C 3 should function as a master terminal by calculating the identifier item value of the file, namely IC-C, and the partner identifier item value, namely ID-D (FIG. 15, Step S210). For example, if the sum of binary form of ID-C and ID-D is even, the communication terminal having a larger value becomes a master terminal; and if the sum of the values is odd, the communication terminal having the smaller value becomes a master terminal. Determination of master/slave designation is not limited to the foregoing method, and any other, which is capable of determining definitively which of communication terminal C 3 and communication terminal D 4 should function as a master terminal can be used. In the case that communication terminal C 3 should function as a master terminal, control unit 24C obtains “Yes” as a result of the judgment of Step S210. In the case that communication terminal D 4 should function as a master terminal, control unit 24C obtains “No” as a result of the judgment of Step S210.

Next is explained the interrupt-processing requests which communication terminal D 4 sends to communication terminal C 3 in the steps described below.

On the basis of the result of the judgment of Step S210, communication terminal C 3 sends either a master setting request or a slave setting request as an interrupt-processing request to communication terminal D 4 at Step S213 or at Step S214, as explained below. Similarly, communication terminal D 4 sends a master setting request or a slave setting request as an interrupt-processing request to communication terminal C 3. When control unit 24C of communication terminal C 3 receives a master setting request, it suspends its current process, reads out setting management information file 251C, updates the master/slave item value with “1” of the file, and then restarts the suspended process. Similarly, when control unit 24C receives a slave setting request, it suspends its current process, reads out setting management information file 251C, updates the master/slave item value of the file with “2”, and then restarts the suspended process.

These interrupt-processing requests are sent only in the master/slave determination stage, but they can be received both in the master/slave determination stage and the connection authentication stage.

In the case that control unit 24C obtains “Yes” at Step S210, control unit 24C reads out setting management information file 251C and obtains the master/slave item value of the file (Step S211). If communication terminal C 3 has already received a master setting request from communication terminal D 4 at this time, control unit 24C obtains “1” at Step S211; whereas if communication terminal C 3 has not received a master setting request from communication terminal D 4, control unit 24C obtains “0” at Step S211. Since communication terminal C 3 and communication terminal D 4 carry out the same calculation, in this case, communication terminal D 4 cannot send a slave setting request to communication terminal C 3, and control unit 24C cannot obtain “2” at Step S211.

In the case that control unit 24C obtains “0” at Step S211, control unit 24C waits for a predetermined brief period of time, for example, one second, and moves to Step S211 (Step S212). This operation is repeated if the master/slave item value of setting management information file 251 C is “0” at Step S211. At this stage, communication terminal C 3 remains in a waiting state until a master setting request is sent from communication terminal D 4.

In the case that control unit 24C obtains “1” at Step S211, it sends a slave setting request to communication terminal D 4 (Step S213), which is, in effect, a confirmation notice that communication terminal C 3 has obtained the same result as communication terminal D 4. After Step S213, control unit 24C moves to Step S219, which is explained below.

In the case that control unit 24C obtains “No” at Step S210, control unit 24C sends a master setting request to communication terminal D 4 (Step S214). Thus, communication terminal C 3 notifies the calculation result to communication terminal D 4 and requests communication terminal D 4 to confirm the result.

After control unit 24C sends a master setting request to communication terminal D 4, it reads out setting management information file 251C and obtains the master/slave item value (Step S215). If, at this time, communication terminal C 3 has already received a slave setting request from communication terminal D 4, control unit 24C obtains “2” at Step S215. If communication terminal C 3 has yet not received a slave setting request from communication terminal D 4, control unit 24C obtains “0” at Step S215. Since communication terminal C 3 and communication terminal D 4 carry out the same calculation, communication terminal D 4 cannot send a master setting request to communication terminal C 3, and control unit 24C cannot obtain “1” at Step S215.

In the case that control unit 24C obtains “0” at Step S215, control unit 24C waits for a predetermined brief period of time, for example, one second, and moves to Step S215 (Step S216). This operation is repeated if the master/slave item value of setting management information file 251C is “0” at Step S215. At this stage, communication terminal C 3 remains in a waiting state until a slave setting request is sent from communication terminal D 4.

In the case that control unit 24C obtains “2” at Step S215, it moves to Step S217 explained below.

[2.2.3] Parameter Setting Stage

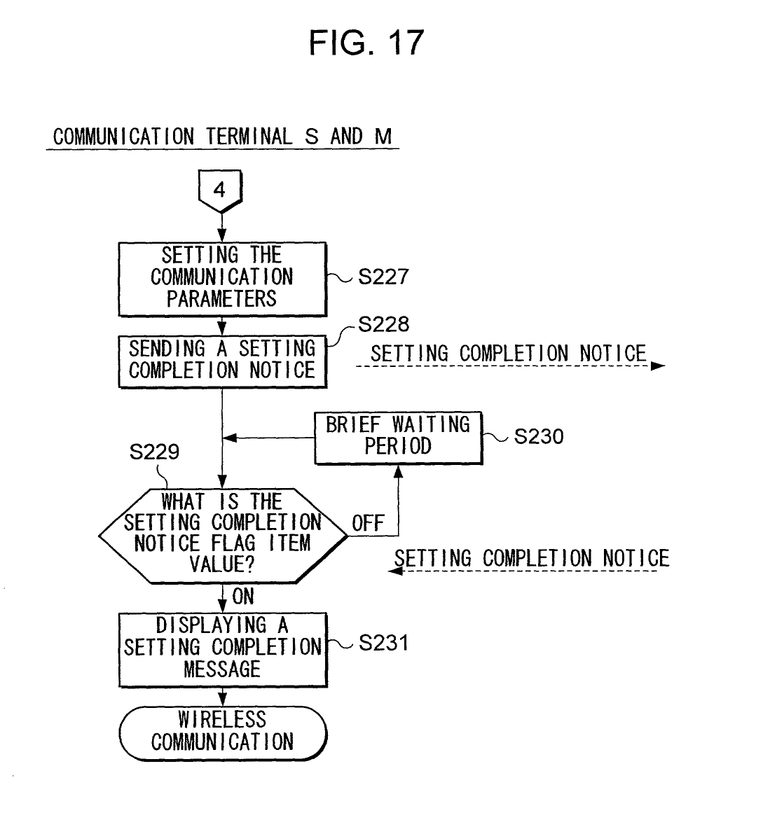

After completion of the master/slave determination stage explained above, communication terminal C 3 and communication terminal D 4 carry out parameter setting for their wireless communication. Explanation will be made with reference to FIG. 17.

Following is an explanation of the operation of the communication terminal M, which functions as a master terminal, and the communication terminal S, which functions as a slave terminal. As will be apparent in the context of the following explanation, in the case that communication terminal C 3 is a master terminal, operation of communication terminal C 3 is given by replacing the letter “M” with “C”; whereas in the case that communication terminal C 3 is a slave terminal, operation of communication terminal C 3 is given by replacing the letter “S” with “C”. In the same way, operation of communication terminal D 4 is given. However, to distinguish like components of the communication terminal M and the communication terminal S, the letters “M” and “S” are placed after respective like components.

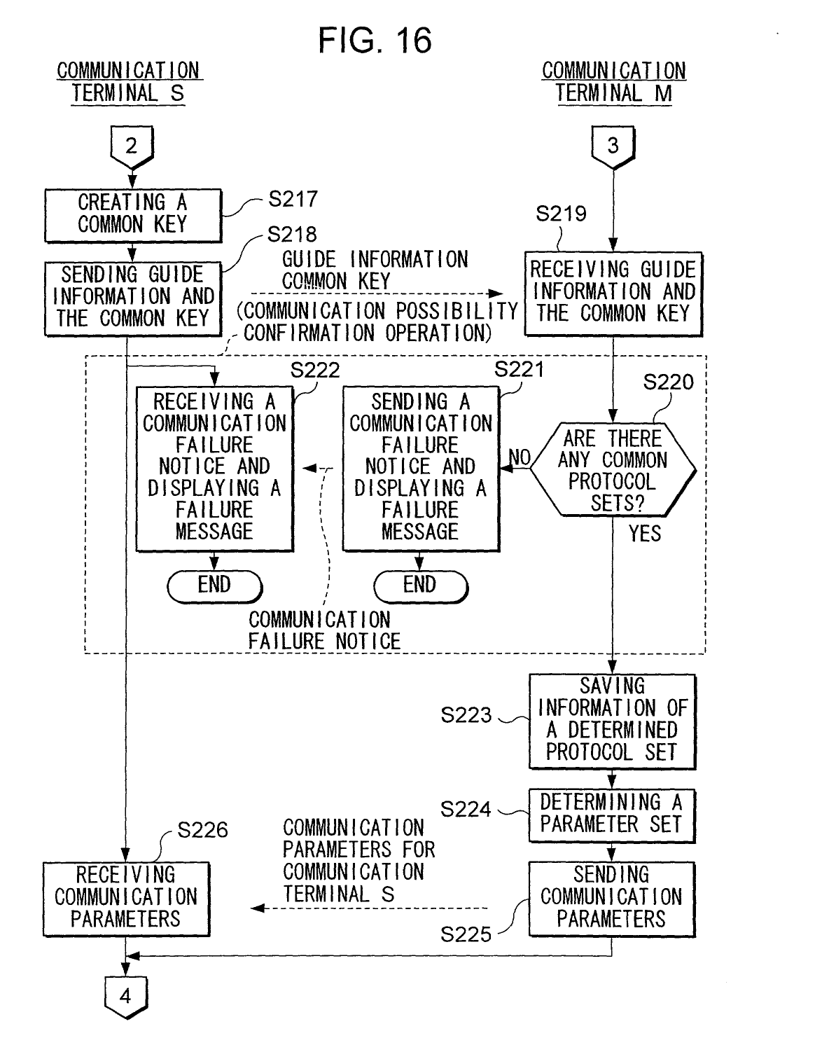

First, control unit 24S of the communication terminal S creates an arbitrary cryptograph key, reads out setting management information file 251S, and updates the common key item value of the file with the created cryptograph key (referred to as “Key-2” hereafter) (FIG. 16, Step S217). Cryptograph keys are combinations of figures, letters, and symbols, and they are created by functions which can create random numbers. There are many well known methods to create random numbers, and explanation is omitted.

Next, control unit 24S reads out own protocol information file 253S, and obtains the MAC address field values and the protocol set field values of all of the records of the file (referred to as “Protocol Set Table S” hereafter), maintaining their value correspondences in each record. Protocol Set Table S functions as guide information for protocol sets which the communication terminal S can use in communicating via wireless communication unit 21S. Then control unit 24S sends Protocol Set Table S and Key-2, created at Step S217, to the communication terminal M (Step S218). After control unit 24M of the communication terminal M receives Protocol Set Table S and Key-2, it reads out partner protocol information file 254M, and updates the MAC address field value and the protocol set field value of each record of the file with the MAC address field value and the protocol set field value of each record of Protocol Set Table S. Then control unit 24M reads out setting management information file 251M and updates the common key item value with Key-2 (Step S219).

Next, control unit 24M reads out own protocol information file 253M and partner protocol information file 254M, and judges if any values of records of the protocol set fields of the two files are the same (Step S220). In the case that the protocol set fields of the two files have values which show the same names of protocol sets, control unit 24M obtains “Yes” as a result of the judgment of Step S220. In the case that they have no value which shows the same name of protocol set, control unit 24M obtains “No” as a result of the judgment of Step S220.

In the case that control unit 24M obtains “No” at Step S220, control unit 24M sends a communication failure notice to the communication terminal S. Control unit 24M then displays a message stating that setting for the wireless communication cannot be executed by display unit 23M (Step S221). After this step, control unit 24M finishes its operation.

When control unit 24S receives a communication failure notice from communication terminal M, it displays a message stating that setting for the wireless communication cannot be executed by display unit 23S (Step S222). After this step, control unit 24S finishes its operation. Hereafter, the series of operations described in Step S220 to Step S222 will be referred to as a “communication possibility confirmation operation”.

In the case that control unit 24M obtains “Yes” at Step S220, control unit 24M extracts from the records of own protocol information file 253M, any which has a protocol set field value which is the same as a protocol set field value of a record of partner protocol information file 254M. In the case that several records are extracted from own protocol information file 253M, control unit 24M compares priority field values of the records, and selects that which has the lowest priority field value. In the case that only one record is extracted from the file, control unit 24M selects that record. Then control unit 24M reads out determined protocol information file 255M, and updates the own MAC address field value of the one record of the file with the MAC address field value of the selected record (referred to as “MAC-M” hereafter); then control unit 24M updates the protocol set field value of the one record of the file with the protocol set field value of the selected record (referred to as “Determined Protocol Set 2” hereafter). Next, control unit 24M retrieves, from the records of partner protocol information file 254M, that record which has a protocol set field value which is the same as Determined Protocol Set 2, and updates the partner MAC address field value of the one record of determined protocol information file 255M with the MAC address field value of the retrieved record (referred to as “MAC-S” hereafter) (Step S223).

Next, control unit 24M determines which communication parameters are required to be changed to enable the communication terminal S to perform wireless communication with the communication terminal M using the protocol set which Determined Protocol Set 2 shows. This determination is made by using the parameter set field values of the record which is retrieved from own protocol information file 253M and selected at Step S223 (Step S224). Hereafter, the parameter set for the communication terminal M will be referred to as “Parameter Set M” and that for the communication terminal S as “Parameter Set S”, respectively.

Using an actual example, the operation to determine the parameter sets at Step S224 will now be explained. Here, it is supposed that Determined Protocol Set 2 shows “IEEE802.11b TCP/IP”, and the parameter set field values of the record of own protocol information file 253M, whose protocol set field value shows “IEEE802.11b TCP/IP”, are as follows:

Parameter 1 “IEEE802.11b: Mode =Infrastructure”

Parameter 2 “IEEE802.11b: Channel ID=3”

Parameter 3 “IP Address/Subnet Mask=192.168.0.220/255.255.255.0”

In this case, control unit 24M determines the following parameters as Parameter Set M:

Parameter 1 “IEEE802.11b: Mode=Ad Hoc”

Parameter 2 “IEEE802.11b: Channel ID=5”

Control unit 24M also determines the following parameters as Parameter Set S:

Parameter 1 “IEEE802.11b: Mode=Ad Hoc”

Parameter 2 “IEEE802.11b: Channel ID=5”

Parameter 3 “IP Address/Subnet Mask=192.168.0.221/255.255.255.0”

Here, Infrastructure mode means a form of communication with relay by an access point, and Ad Hoc mode means a form of peer-to-peer communication, which is ruled in IEEE802.11b.

On the basis of the original setting, the communication terminal M uses Infrastructure mode in IEEE802.11b. Control unit 24M selects Ad Hoc mode as the communication mode of IEEE802.11b, so as to enable one-to-one communication in wireless LAN system 2. On the basis of the original setting, for the channel ID of IEEE802.11b, the communication terminal M uses 3. Channel ID 3 shows the frequency channel which is used in the wireless LAN to which the communication terminal M originally belongs, and control unit 24M selects 5 as an unused channel ID, which is different from 3, to avoid channel collision which would otherwise occur if 3 were to also be used as a channel ID in wireless LAN system 2.

On the basis of the original setting, for parameters of TCP/IP, the communication terminal M uses 192.168.0.220 as IP address, and 255.255.255.0 as subnet mask, respectively. There is no need to change the IP address and the subnet mask for the communication terminal M, and Parameter Set M does not contain parameters of IP address and subnet mask. On the other hand, an IP address and a subnet mask for the communication terminal S must be a set which shows an address which belongs to the same network as the communication terminal M, and which is different from the address of the communication terminal M. Consequently, control unit 24M selects 192.168.0.221 as an IP address and 255.255.255.0 as a subnet mask as parameters for the communication terminal S.

After control unit 24M determines Parameter Set M and Parameter Set S at Step S224, it reads out determined protocol information file 255M, and updates the parameter set field values of the one record of the file with Parameter Set M. Then control unit 24M obtains the own MAC address field value of the record, namely MAC-M, and the protocol set field value of the record, namely Determined Protocol Set 2, and sends MAC-M, Determined Protocol Set 2, and Parameter Set S to the communication terminal S (Step S225). This information consists of communication parameters which enable the communication terminal S to perform wireless communication with the communication terminal M via wireless communication unit 21S.

After control unit 24S receives MAC-M, Determined Protocol Set 2, and Parameter Set S from the communication terminal M, it reads out determined protocol information file 255S, and updates the partner MAC address field value of the one record of the file with MAC-M, the protocol set field value of the record with Determined Protocol Set 2, and the parameter set field value of the record with Parameter Set S, respectively. Then control unit 24S reads out own protocol information file 253S, retrieves, from the records of the file, that record which has a protocol set field value which is the same as Determined Protocol Set 2, obtains the MAC address field value of the retrieved record, namely MAC-S, and updates the own MAC address field value of the one record of determined protocol information file 255S with MAC-S (Step S226).

The following operation is performed simultaneously in the communication terminal M and the communication terminal S in the same way. Consequently, only the operation of the communication terminal M is described here. The operation of the communication terminal S is given by exchanging the signs “M” and “S”.

Control unit 24M reads out determined protocol information file 255M, and sends the protocol set field value of the one record of the file, namely Determined Protocol Set 2, and the parameter set field values of the record, namely Parameter Set M, to wireless communication unit 21M. After wireless communication unit 21M receives Determined Protocol Set 2 and Parameter Set M, it updates the parameters of communication protocol set corresponding to Determined Protocol Set 2 in its nonvolatile memory with Parameter Set M. When wireless communication unit 21M completes the change of parameters, it notifies control unit 24M of the completion of parameter setting (FIG. 17, Step S227).

After control unit 24M receives the notice of completion of setting from wireless communication unit 21M, it sends a setting completion notice to the communication terminal S (Step S228).

Next is explained interrupt-processing requests which the communication terminal S sends in the following steps to the communication terminal M. As explained above, the communication terminal M sends a setting completion notice to the communication terminal S at Step S228. Similarly, the communication terminal S sends a setting completion notice to the communication terminal M. When control unit 24M receives a setting completion notice, it suspends its current process, reads out setting management information file 251M, updates the setting completion notice flag item value with “ON”, and restarts the suspended process.

After control unit 24M sends a setting completion notice at Step S228, it reads out setting management information file 251M, and judges if the setting completion notice flag item value is “ON” (Step S229). If the communication terminal M has already received a setting completion notice from the communication terminal S at this time, control unit 24M obtains “Yes” as a result of the judgment at Step S229. If the communication terminal M has not received a setting completion notice from the communication terminal S at this time, control unit 24M obtains “No” as a result of the judgment at Step S229.

In the case that control unit 24M obtains “No” at Step S229, control unit 24M waits for a predetermined brief period of time, for example, one second, and moves to Step S229 (Step S230). This operation is repeated if the setting completion notice flag item value of setting management information file 251M is “OFF” at Step S211. At this stage, the communication terminal M remains in a waiting state until a setting completion notice is sent from the communication terminal S.

In the case that control unit 24M obtains “Yes” at Step S229, control unit 24M displays a message stating that parameter setting for wireless communication is completed, by display unit 23M (Step S231).

Once users of the communication terminal M and the communication terminal S are informed by a displayed message that parameter setting for wireless communication has been completed, they can disconnect cable communication unit 20M and cable communication unit 20S.

By the operation explained above, the communication terminal M and the communication terminal S are enabled to perform one-to-one wireless communication using wireless communication unit 21M and wireless communication unit 21S.

[2.2.4] The Method of Communication using Common Key

When communication terminal C 3 and communication terminal D 4 perform one-to-one wireless communication in wireless LAN system 2 after completion of the communication parameter setting stage explained above, they encrypt and decode the communicated information using their common cryptograph key. The communication operation will now be explained. In the following explanation, communication terminal C 3 sends information to communication terminal D 4, but this function is interchangeable between the terminals.

When communication terminal C 3 needs to send information to communication terminal D 4, first, control unit 24C reads out determined protocol information file 255C, and compares the MAC address value of the receiver, communication terminal D 4, (referred to as “MAC-D” hereafter) with the partner MAC address field value of the one record of the file. This comparison is made to confirm that the receiver of the information is the partner communication terminal in the one-to-one wireless communication established in wireless LAN system 2. If the values match, control unit 24C reads out setting management information file 251C, and encrypts the information which is to be sent to communication terminal D 4, using the common key item value of the file, namely Key-2. Then, control unit 24C formats the encrypted information using the communication protocol set which the protocol set field value of the record of determined protocol information file 255C shows. Then control unit 24C obtains the own MAC address field value of the one record of determined protocol information file 255C (referred to as “MAC-C” hereafter), attaches MAC-D as the sender's MAC address and MAC-C as the receiver's MAC address to the formatted information, and sends the information to communication terminal D 4 through wireless communication unit 21C.

When control unit 24D of communication terminal D 4 receives the encrypted information from communication terminal C 3 through wireless communication unit 21D, first, it obtains the sender's MAC Address, namely MAC-C, from the received information. Then control unit 24D reads out determined protocol information file 255D, and compares MAC-C with the partner MAC address field value of the one record of the file. This comparison is made to confirm that the sender of the information is the partner communication terminal in the one-to-one wireless communication established in wireless LAN system 2. If the values match, control unit 24D reads out setting management information file 251D, and decodes the received information using the common key item value of the file, namely Key-2.

[2.3] Advantages of the Second Embodiment.

In the second embodiment, users of communication terminals can carry out parameter setting for wireless communication by simply bringing into contact with each other cable communication units of their communication terminals. Moreover, there is no need to start any application software to perform parameter setting. As will be obvious, communication parameter setting can thereby be easily carried out by any user.

In the second embodiment, users of communication terminals need only input their pre-registered passwords in a communication parameter setting operation. Additionally, in communication parameter setting, a communication protocol to which a higher priority is given in one of communication terminals is selected automatically, and thus there is no possibility of inappropriate communication protocols being selected, which would otherwise severely compromise communication efficiency achieved by automization.

In wireless LAN system 2, according to the second embodiment of the present invention, information exchanged between communication terminals is encrypted, and therefore protected from unauthorized access. Encryption is a well-known art, and there are two type of cryptography: common key cryptography and public key cryptography. Common key cryptography is much far faster than public key cryptography, but it involves an inherent risk that if cryptograph keys are misappropriated, information content can then also be easily misappropriated. In wireless LAN system 2, common key cryptography is used but keys are exchanged securely because they are sent and received by direct contact between two communication terminals.

[3] The Third Embodiment

[3.1] The Configuration of the Third Embodiment

[3.1.1] The Configuration of the Wireless LAN System

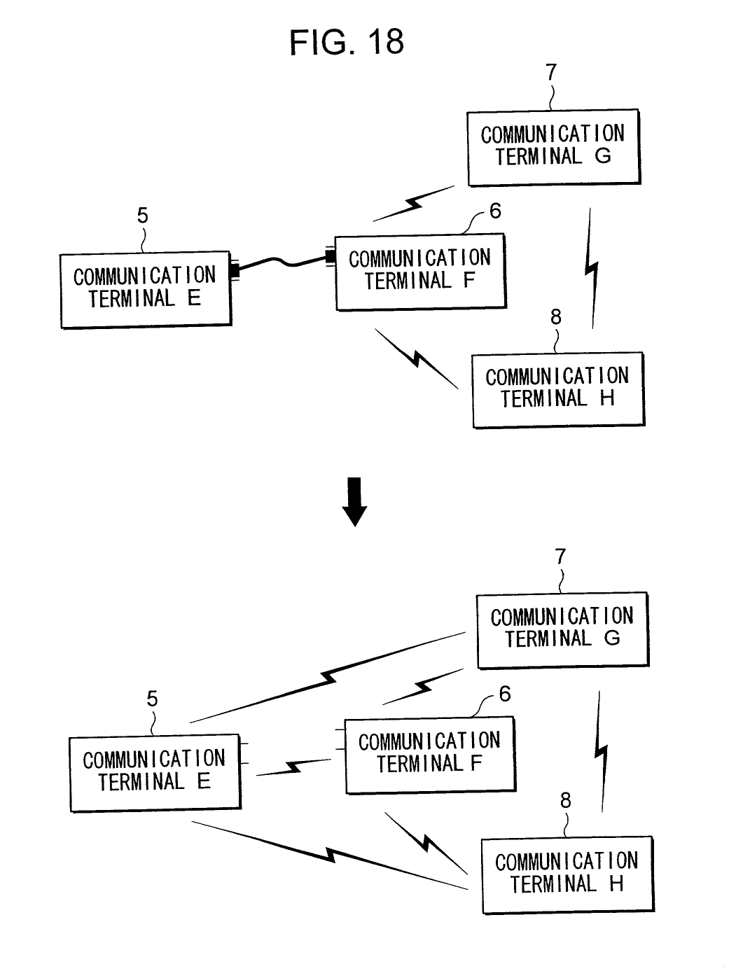

In the third embodiment of the present invention, a communication terminal newly connects to a wireless LAN system using the communication parameter setting method of the present invention, and is enabled to communicate with other communication devices in the wireless LAN. FIG. 18 shows a state of the wireless LAN system in the communication parameter setting stage and a state after communication parameter setting in the third embodiment is completed. Hereafter, the LAN system in a state in which communication parameter setting has been completed in accordance with the third embodiment of the present invention will be referred to as “wireless LAN system 3”.

In the third embodiment of the present invention, the wireless LAN system is composed of a communication terminal E 5, a communication terminal F 6, a communication terminal G 7, and a communication terminal H 8. Communication terminal F 6, communication terminal G 7, and communication terminal H 8 are connected to each other by wireless communication; and communication terminal E 5 is connected via a data cable to communication terminal F 6 to connect the wireless LAN system for communication with communication terminal F 6, communication terminal G 7, and communication terminal H 8.

In the third embodiment, a user of communication terminal E 5 sends a start instruction for communication parameter setting to communication terminal E 5, using a manipulation unit of communication terminal E 5. Upon receiving the instruction, communication terminal E 5 functions as a communication device which requests communication parameters required for wireless communication in wireless LAN system 3 be determined; and communication terminal F 6 functions as a communication device which determines the communication parameters. Consequently, communication terminal F 6 determines communication parameters required to be changed to enable communication terminal E 5 to perform wireless communication in wireless LAN system 3, and sends determined communication parameters to communication terminal E 5. Communication terminal E 5 receives the communication parameters from communication terminal F 6, and changes its communication parameters on the basis of the received communication parameters. In the third embodiment, similar to the second embodiment, the parameters related to communication protocols in middle layers, such as TCP/IP, and so on, are also set.

[3.1.2] The Configuration of the Communication Terminals

[3.1.2.1] The Configuration of the Communication Terminals with Cable Communication Units

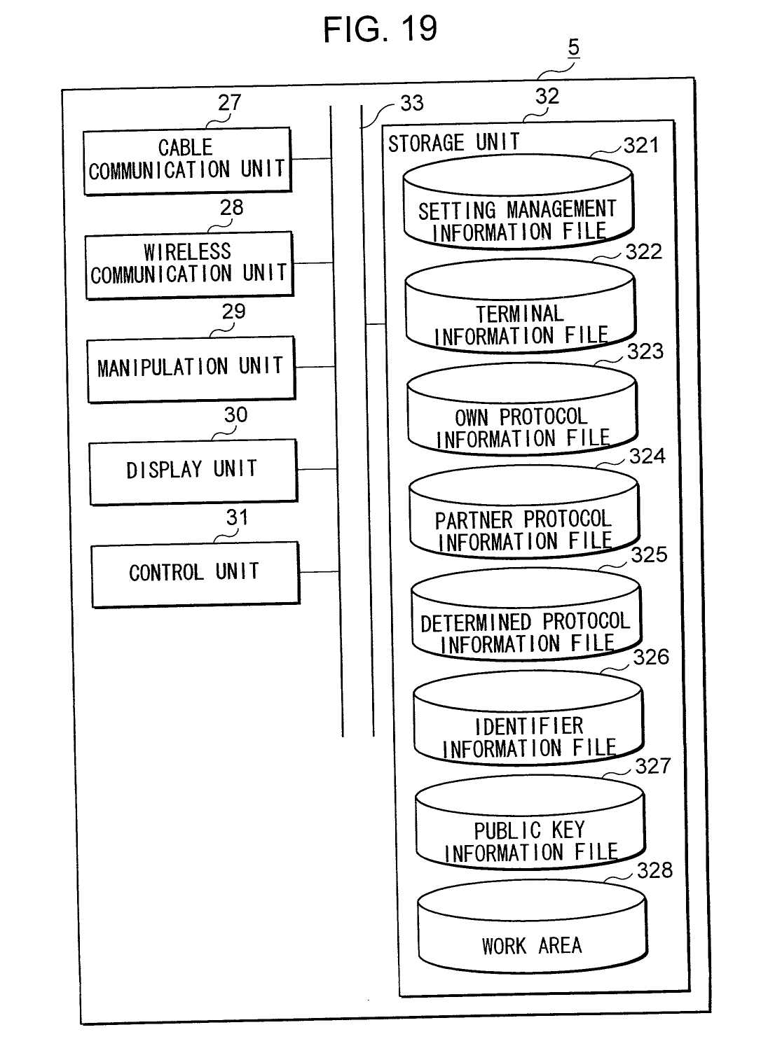

In the third embodiment, communication terminal E 5 is enabled to perform wireless communication with other communication terminals by being connected via a data cable to communication terminal F 6. FIG. 19 shows the configuration of communication terminal E 5. Since the configuration of communication terminal F 6 is the same as that of communication terminal E 5, explanation of the configuration of communication terminal F 6 is omitted.

Communication terminal E 5 has a cable communication unit 27, a wireless communication unit 28, a manipulation unit 29, a display unit 30, a control unit 31, and a storage unit 32. All of these components are electrically connected to each other through a bus 33.

The functions and the configurations of wireless communication unit 28, manipulation unit 29, display unit 30, and control unit 31 are the same as those of wireless communication unit 21, manipulation unit 22, display unit 23, and control unit 24 of communication terminal C 3 in the second embodiment, respectively, and explanation of the units is therefore omitted. The function of storage unit 32 is also the same as that of storage unit 25 of communication terminal C 3 in the second embodiment, and explanation is therefore also omitted.

The function of cable communication unit 27 is the same as that of cable communication unit 20 of communication terminal C 3 in the second embodiment, but has a configuration designed for cable, not direct, connection.

Storage unit 32 stores a setting management information file 321, a terminal information file 322, an own protocol information file 323, a partner protocol information file 324, a determined protocol information file 325, an identifier information file 326, and a public key information file 327, and has a work area 328.

The configurations of terminal information file 322, partner protocol information file 324, and the function of work area 328 are the same as those of terminal information file 252, partner protocol information file 254, and work area 256 of communication terminal C 3 in the second embodiment, respectively, and explanation of them is therefore omitted.

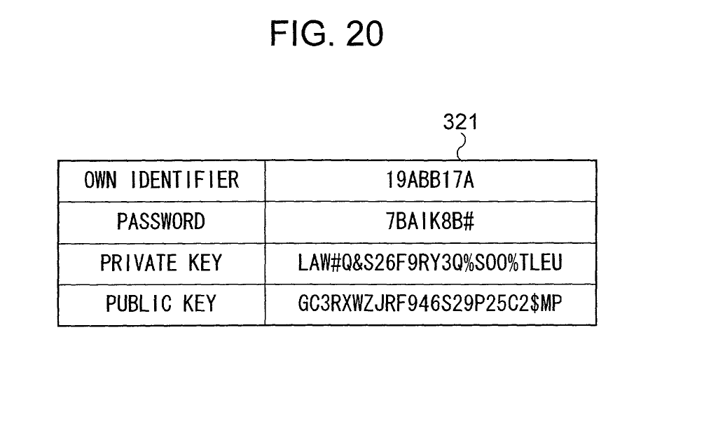

FIG. 20 shows the configuration of setting management information file 321. Setting management information file 321 has an own identifier item, a password item, a private key item, and a public key item. The functions of the own identifier item and password item are the same as those of setting management information file 251 of communication terminal C 3 in the second embodiment. The private key item contains information on a cryptograph key by use of which communication terminal E 5 decodes encrypted information which communication terminal E 5 receives from other communication terminals in wireless LAN system 3. The public key item contains information on a cryptograph key by use of which communication terminal E 5 encrypts information which communication terminals other than communication terminal E 5 send to communication terminal E 5 in wireless LAN system 3. Values of the private key item and the public key item make a pair, and information which is encrypted using the public key item value can be decoded using the private key item value.

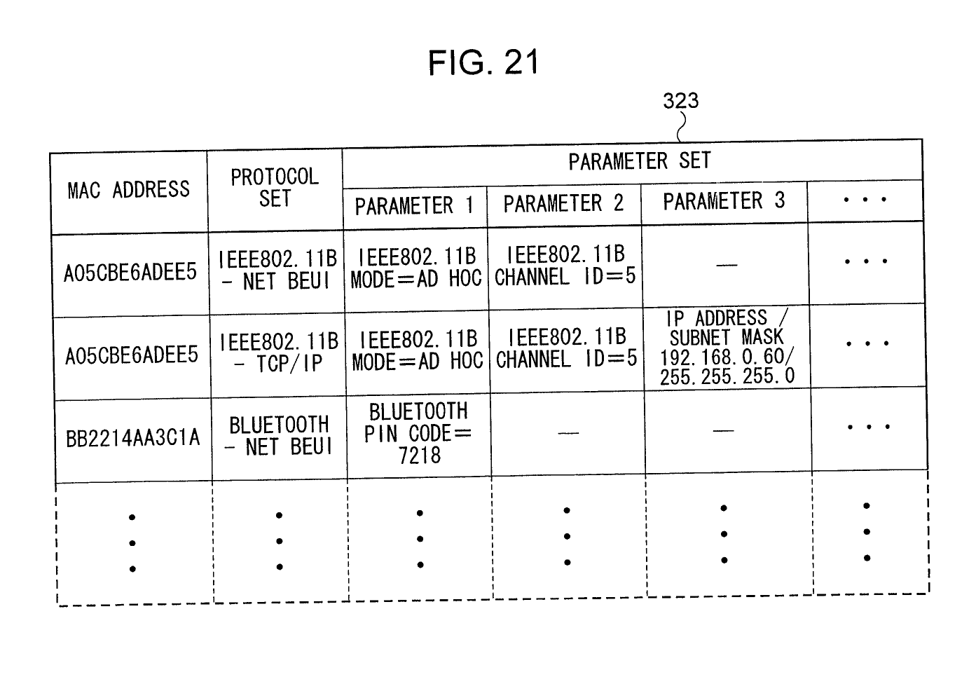

FIG. 21 shows the configuration of own protocol information file 323. The configuration of own protocol information file 323 is almost the same as that of own protocol information file 253 of communication terminal C 3 in the second embodiment, but it does not have a priority item since such an item is not necessary in the third embodiment.

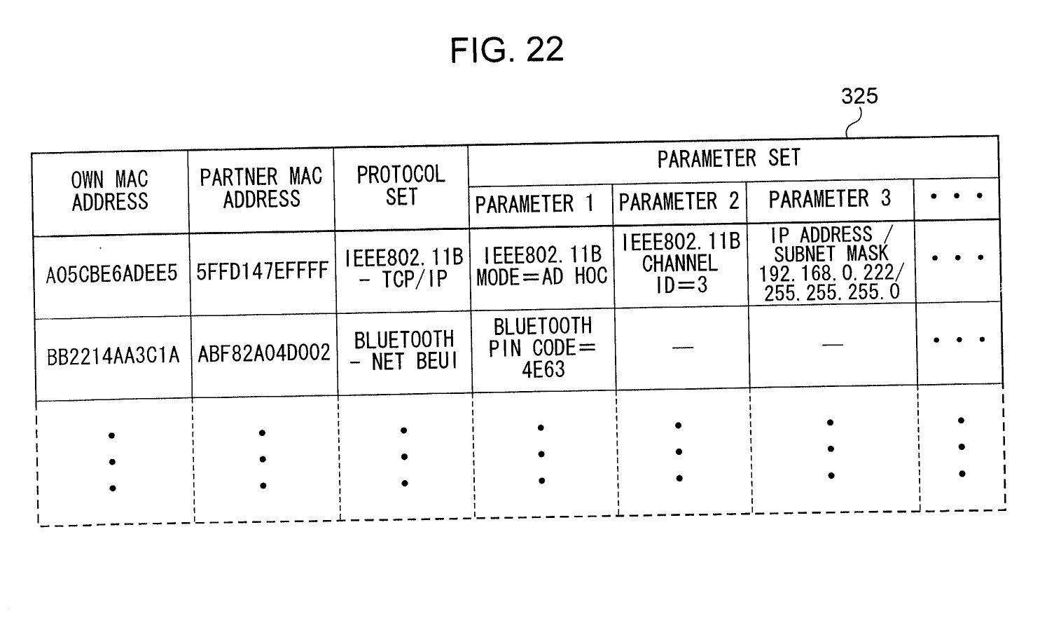

FIG. 22 shows the configuration of determined protocol information file 325. The configuration of determined protocol information file 325 is almost the same as that of determined protocol information file 255 of communication terminal C 3 in the second embodiment, but the number of records it has is the same as that of communication protocol sets which are usable by both communication terminal E 5 and communication terminal F 6; each record consists of an aggregation of information on one communication protocol set.

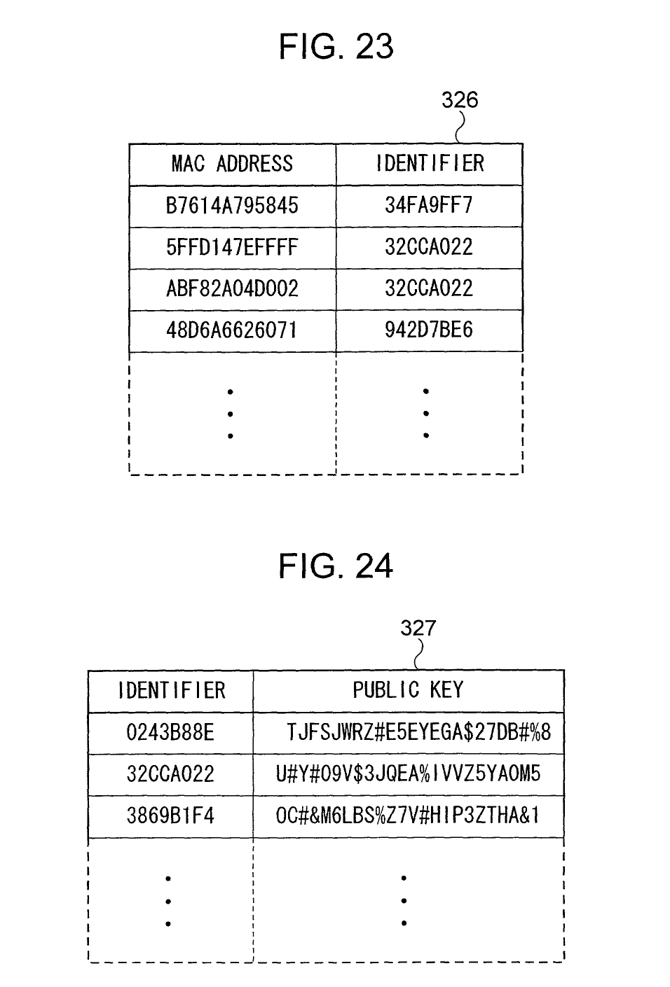

FIG. 23 shows the configuration of identifier information file 326. Identifier information file 326 has several records, and the number of records is the same as that of communication terminals which have previously communicated with communication terminal E 5 in wireless LAN system 3. Each record of the file has a MAC address field and an identifier field. The MAC address field contains a MAC address of a target communication terminal, and the identifier field contains an identifier of a target communication terminal. In the case that one communication terminal has several MAC addresses, identifier field values of records corresponding to those MAC addresses are the same.

FIG. 24 shows the configuration of public key information file 327. Public key information file 327 has several records, and the number of records is the same as that of communication terminals with which communication terminal E 5 has previously communicated in wireless LAN system 3. Each record has an identifier field and a public key field. The identifier field contains an identifier of a target communication terminal, and the public key field contains information on a public key of a target communication terminal.

[3.1.2.2] The Configuration of the Communication Terminals without Cable Communication Units

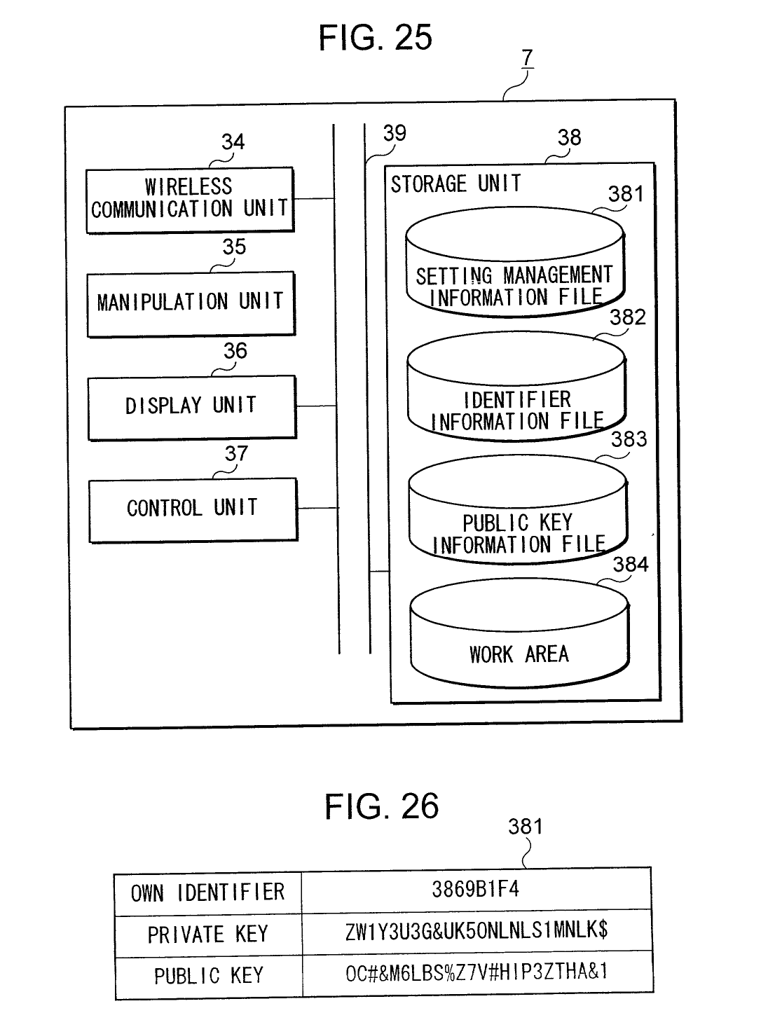

In the third embodiment, communication terminal G 7 and communication terminal H 8 are not connected to communication terminal E 5, and their configurations are different from that of communication terminal E 5. FIG. 25 shows the configuration of communication terminal G 7. The configuration of communication terminal H 8 is the same as that of communication terminal G 7, and thus explanation of the configuration of communication terminal H 8 is omitted.

Communication terminal G 7 has a wireless communication unit 34, a manipulation unit 35, a display unit 36, a control unit 37, and a storage unit 38. All of these components are electrically connected to each other through a bus 39.

The functions and the configurations of wireless communication unit 34, manipulation unit 35, display unit 36, and control unit 37 are the same as those of wireless communication unit 21, manipulation unit 22, display unit 23, and control unit 24 of communication terminal C 3 in the second embodiment, respectively, and explanation of the units is therefore omitted. The function of storage unit 38 is also the same as that of storage unit 25 of communication terminal C 3 in the second embodiment, and explanation is therefore also omitted.

Storage unit 38 stores a setting management information file 381, an identifier information file 382, and a public key information file 383, and it has a work area 384.

The configurations of identifier information file 382 and public key information file 383 are the same as those of the identifier information file 326 and public key information file 327 of communication terminal E 5, respectively, and explanation of them is therefore omitted. The function of work area 328 is also the same as that of work area 256 of communication terminal C 3 in the second embodiment, and explanation is therefore also omitted.

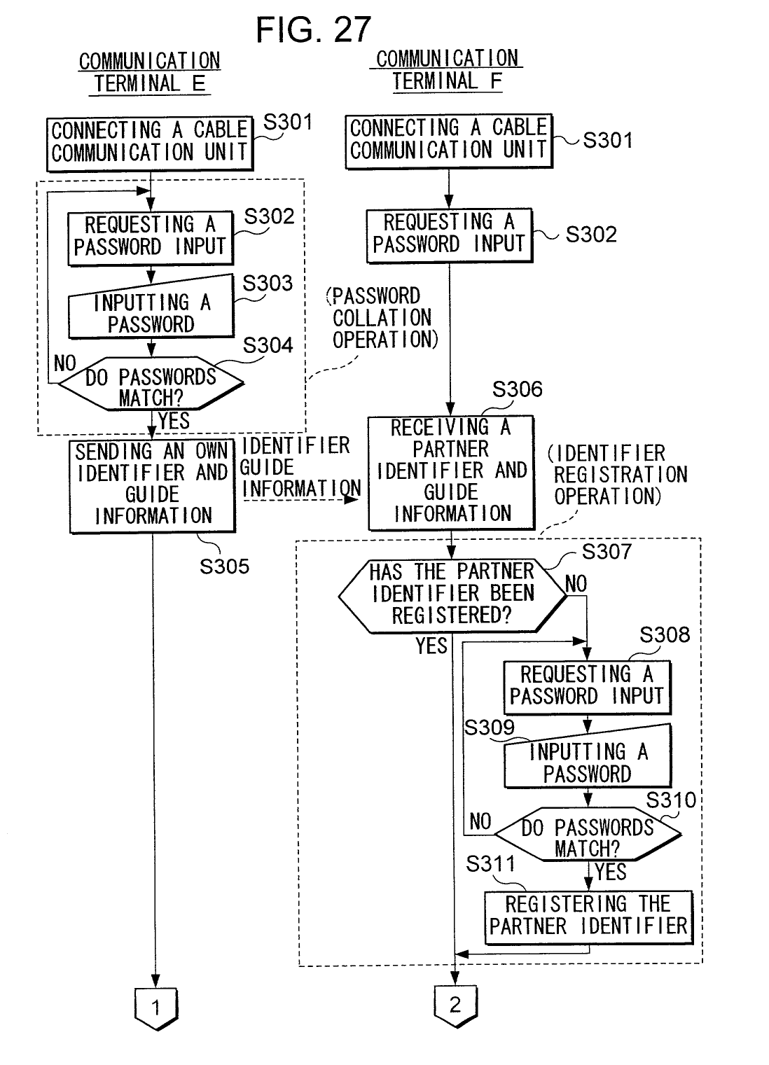

FIG. 26 shows the configuration of setting management information file 381. Setting management information file 381 has an own identifier item, a private key item, and a public key item. The function of the own identifier item is the same as that of setting management information file 251 of communication terminal C 3 in the second embodiment. The functions of the private key item and the public key item are the same as those of setting management information file 321 of communication terminal E 5.

[3.2] The Operation of the Third Embodiment

The communication parameter setting operation for wireless LAN system 3 in the third embodiment, and the communication operation performed after the communication parameter setting will now be described. The communication parameter setting consists of a connection authentication stage and a parameter setting stage. Hereafter, to distinguish like components of communication terminal E 5, communication terminal F 6, and communication terminal G 7, the letters “E”, “F”, and “G” are placed after respective numbers which denote like corresponding components.

In the following operation of the connection authentication stage and the parameter setting stage, cable communication unit 27E and cable communication unit 27F are used for all communication between communication terminal E 5 and communication terminal F 6.

[3.2.1] The Connection Authentication Stage

First, communication terminal F 6 authenticates a connection of communication terminal E 5 to communication terminal F 6, responding to a connection request sent from communication terminal E 5. Referring to FIG. 27, there is now provided explanation of its operation.

A user of each of communication terminal E 5 and communication terminal F 6 connects one end of a data cable to cable communication unit 27E and cable communication unit 27F, respectively. When a connection is made using the data cable, it is detected by control unit 31E and control unit 31D (FIG. 27, Step S301).

Next, control unit 31E performs a password collation operation. The password collation operation here is almost the same as the series of operations described in Step S206 to Step S208 of the second embodiment, and detailed explanation is therefore omitted (from Step S302 to Step S304). However, a message displayed in display unit 30E at Step S302 requests that only a user of a communication terminal newly connected to the wireless LAN system input his/her password. This password input step functions both to confirm an authority of a user of communication terminal E 5 who is attempting to connect to the wireless LAN system, and also to establish in communication terminal E 5 that a partner communication terminal of communication terminal E 5 will act to determine communication parameters in the following operation.

Following Step S301, control unit 31F of communication terminal F 6 displays by display unit 30F the same message as control unit 31E displays at Step S302, but a user of communication terminal F 6 will not input any password because communication terminal F 6 is newly connected to the wireless LAN system. Therefore, control unit 31F does not perform those operations performed at Step S303 and Step S304 by control unit 31E when a user completes password collation.

In the case that two passwords match at Step 304, first, control unit 31E reads out setting management information file 321E, and obtains the own identifier item value of the file (referred to as “ID-E” hereafter). Then control unit 31E reads out own protocol information file 323E, and obtains the MAC address field values and the protocol set field values of all of the records of the file (referred to as “Protocol Set Table E” hereafter), keeping their correspondences in each record. Protocol Set Table E function as guide information for protocol sets which communication terminal E 5 can use in communicating via wireless communication unit 28E. Next, control unit 31E sends IE-E and Protocol Set Table E to communication terminal F 6 (Step S305). After Step S305, control unit 31E moves to Step S314 explained below.

After control unit 31F of communication terminal F 6 receives ID-E and Protocol Set Table E, it reads out setting management information file 321F and updates the partner identifier item value of the file with ID-E. Then control unit 31F reads out partner protocol information file 324F and updates the MAC address field value and the protocol set field value of each record of the file with the MAC address field value and the protocol set field value of each record of Protocol Set Table E (Step S306).

Next, communication terminal F 6 performs the identifier registration operation. The identifier registration operation here is the same as the series of operations described in Step S205 to Step S209 of the second embodiment, and explanation is therefore omitted (from Step S307 to Step S311). After Step S311, control unit 31F moves to Step S312 explained below.

[3.2.2] The Parameter Setting Stage

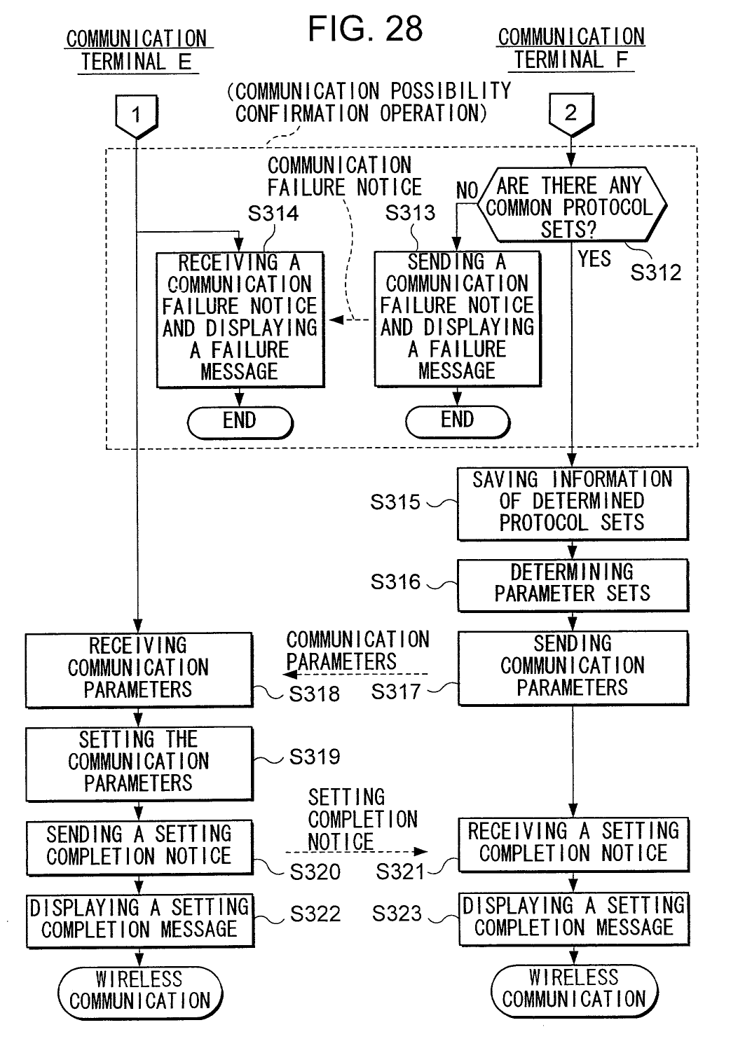

After the connection authentication stage explained above, communication terminal F 6 determines communication parameters which are required to be changed to enable communication terminal E 5 to perform wireless communication in wireless LAN system 3, and communication terminal E 5 carries out parameter setting on the basis of communication parameters which communication terminal F 6 determines. Referring to FIG. 28, its operation will now be explained.

First, communication terminal E 5 and communication terminal F 6 perform a communication possibility confirmation operation. The communication possibility confirmation operation here is the same as the series of operations described in Step S220 to Step S222 of the second embodiment, and explanation is therefore omitted (from Step S312 to Step S314). In the communication possibility confirmation operation here, communication terminal E 5 takes the role performed by the communication terminal S in the second embodiment, and communication terminal F 6 takes that of the communication terminal M.

At Step S312, in the case that the protocol set fields of own protocol information file 323F and partner protocol information file 324F have values which show the same names of protocol sets, and control unit 31F obtains “Yes” as a result of the judgment, control unit 31F extracts from the records of own protocol information file 323F, any which has a protocol set field value which is the same as a protocol set field value of a record of partner protocol information file 324F. In this case, several records can be extracted. Then control unit 31F reads out determined protocol information file 325F, and updates the own MAC address field value and the protocol set field value of each record of the file with the MAC address field value (referred to as “MAC-List-F” hereafter) and the protocol set field value (referred to as “Determined Protocol Set List 3” hereafter) of each extracted record, respectively. Then control unit 31F performs the following operation for each record of determined protocol information file 325F to update the partner MAC address field value of each record of determined protocol information file 325F. Namely, first, control unit 31F retrieves from partner protocol information file 324F, a record which has a protocol set field value which is the same as the protocol set field value of a target record. Next, control unit 31F updates the partner MAC address field value of a target record with the MAC address field value of a retrieved record (Step S315).

Next, control unit 31F reads out determined protocol information file 325F and performs the following operation for each record of the file. Control unit 31F reads out own protocol information file 323F, and retrieves from the file, a record which has a protocol set field value which is the same as the protocol set field value of a target record of determined protocol information file 325F. Then control unit 31F determines, on the basis of the parameter set field values of a retrieved record, communication parameters which are required to be changed to enable communication terminal E 5 to perform wireless communication with other communication terminals using the protocol set which the protocol set field value of a target record shows. Then control unit 31F updates the parameter set field value of a target record with determined communication parameters (Step S316). Hereafter, the parameter sets for communication terminal E 5 determined in Step S316 will be referred to as “Parameter Set List E”.

Using an actual example, the operation to determine the parameter sets at Step S316 will now be explained. Here, it is supposed that Determined Protocol Set List 3 shows “IEEE802.11b TCP/IP” and “Bluetooth NetBEUI”, and the parameter set field values of the records of own protocol information file 323F, whose protocol set field values show “IEEE802.11b TCP/IP” and “Bluetooth NetBEUI” are as follows, respectively:

“IEEE802.11b TCP/IP”

Parameter 1 “IEEE802.11b: Mode=Ad Hoc”

Parameter 2 “IEEE802.11b: Channel ID=3”

Parameter 3 “IP Address/Subnet Mask=192.168.0.220/255.255.255.0”

“Bluetooth NetBEUI”

Parameter 1 “Bluetooth: PIN Code=4E63”

In this case, control unit 31F determines the following parameters as Parameter Set List E:

“IEEE802.11b TCP/IP”

Parameter 1 “IEEE802.11b: Mode=Ad Hoc”

Parameter 2 “IEEE802.11b: Channel ID=3”

Parameter 3 “IP Address/Subnet Mask=192.168.0.222/255.255.255.0”

“Bluetooth NetBEUI”

Parameter 1 “Bluetooth: PIN Code=4E63”

Here, PIN code means a personal identification number code for connection authentication, which is ruled in Bluetooth.

In the wireless LAN which contains communication terminal F 6, IEEE802.11b is used being bound to TCP/IP. Regarding IEEE802.11b, Ad Hoc mode is used as its communication mode, and 3 is used as its channel ID in this wireless LAN. These parameters should be the same in all communication devices in the wireless LAN, and control unit 31F adds a copy of these parameters to Parameter Set List E. Regarding TCP/IP, 192.168.0.xxx (“xxx” is a positive integer less than 256) are used as IP addresses and 255.255.255.0 is used as a subnet mask in the wireless LAN. Control unit 31F checks whether an IP address which neighbors the IP address of communication terminal F 6 is being used by broadcasting it in the wireless LAN, and in the case that it is not being used, adds 192.168.0.222/255.255.255.0 to Parameter Set List E as an unused IP address/subnet mask for communication terminal E 5.

In the wireless LAN, Bluetooth is also used by being bound to NetBEUI. In Bluetooth, all communication devices in the same communication network should use the same PIN code, and control unit 31F adds this parameter to Parameter Set List E. Regarding NetBEUI, there is no need to change parameters in this case, and control unit 31F makes no addition to Protocol Set List E.

After control unit 31F determines Parameter Set List E at Step S316, it reads out determined protocol information file 325F, and sends to communication terminal E 5, the own MAC address field values of all records of the file, namely MAC-List-F; the protocol set field values of all records of the file, namely Determined Protocol Set List 3; and the parameter set field values of all records of the file, namely Parameter Set List E (Step S317). This information consists of communication parameters which enable communication terminal E 5 to perform wireless communication with other communication terminals via wireless communication unit 28E.

After control unit 31E receives MAC-List-F, Determined Protocol Set List 3, and Parameter Set List E from communication terminal F 6, it reads out determined protocol information file 325E, and updates the partner MAC address field value of each record of the file with MAC-List-F, the protocol set field value of each record of the file with a value of each record of Determined Protocol Set List 3, and the parameter set field values of each record of the file with values of each record of Parameter Set List E, respectively (Step S318).

Next, control unit 31E sends the protocol set field values of all records of determined protocol information file 325E, namely Determined Protocol Set List 3, and the parameter set field values of all records of determined protocol information file 325E, namely Parameter Set List E, to wireless communication unit 28E. When wireless communication unit 28E receives Determined Protocol Set List 3 and Parameter Set List E, it updates the parameters of communication protocol sets corresponding to Determined Protocol Set List 3 in its nonvolatile memory with Parameter Set List E. When wireless communication unit 28E completes the change of parameters, it notifies control unit 31E of the completion of parameter setting (Step S319).

After control unit 31E receives the notice of completion of setting from wireless communication unit 28E, it sends a setting completion notice to communication terminal F 6 (Step S320), and control unit 31F of communication terminal F 6 receives the setting completion notice from communication terminal E 5 (Step S321).

After Step S320, control unit 31E displays on display unit 30E a message that parameter setting for wireless communication is complete (Step S322). Similarly, after Step S321, control unit 31F displays a message on display unit 30F that parameter setting for wireless communication is complete (Step S323).

Once users of communication terminal E 5 and communication terminal F 6 are informed by a displayed message that parameter setting for wireless communication has been completed, they can disconnect the cable connecting cable communication unit 27E and cable communication unit 27F. By the operation explained above, communication terminal E 5 is enabled to perform wireless communication with other communication terminals using protocol sets which are included in Determined Protocol Set List 3.

For example, if communication terminal F 6 communicates with communication terminal G 7 using IEEE802.11b TCP/IP, and communicates with communication terminal H 8 using Bluetooth NetBEUI, communication terminal E 5 is able to communicate with communication terminal F 6 using IEEE802.11b TCP/IP and Bluetooth NetBEUI; communicate with communication terminal G 7 using IEEE802.11b TCP/IP; and communicate with communication terminal H 8 using Bluetooth NetBEUI.

[3.2.3] The Method of Communication using Public Key

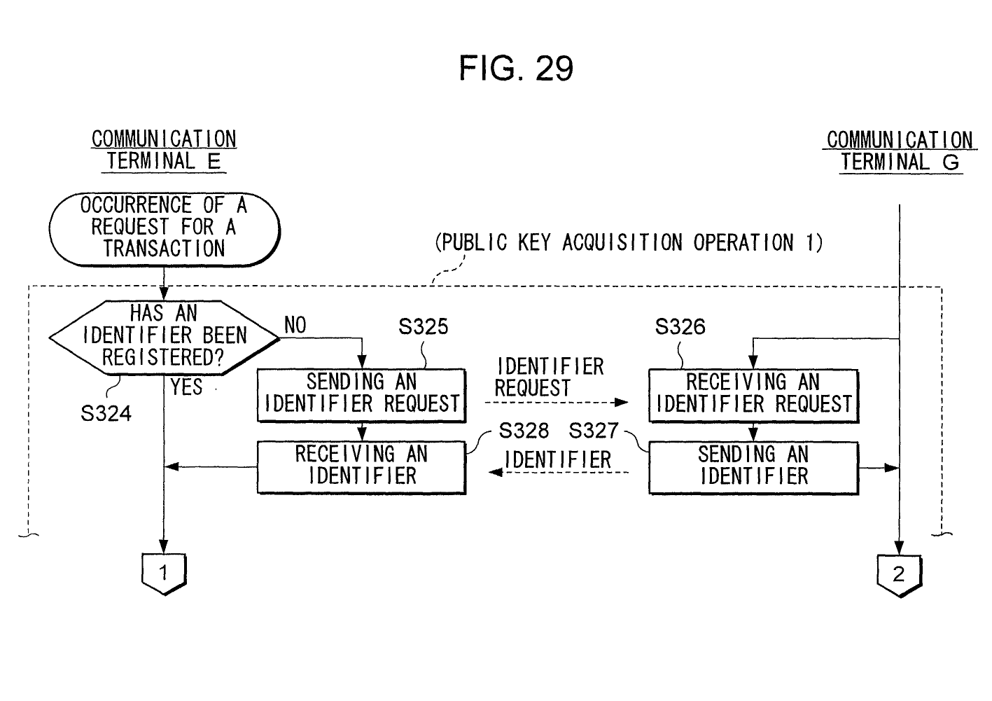

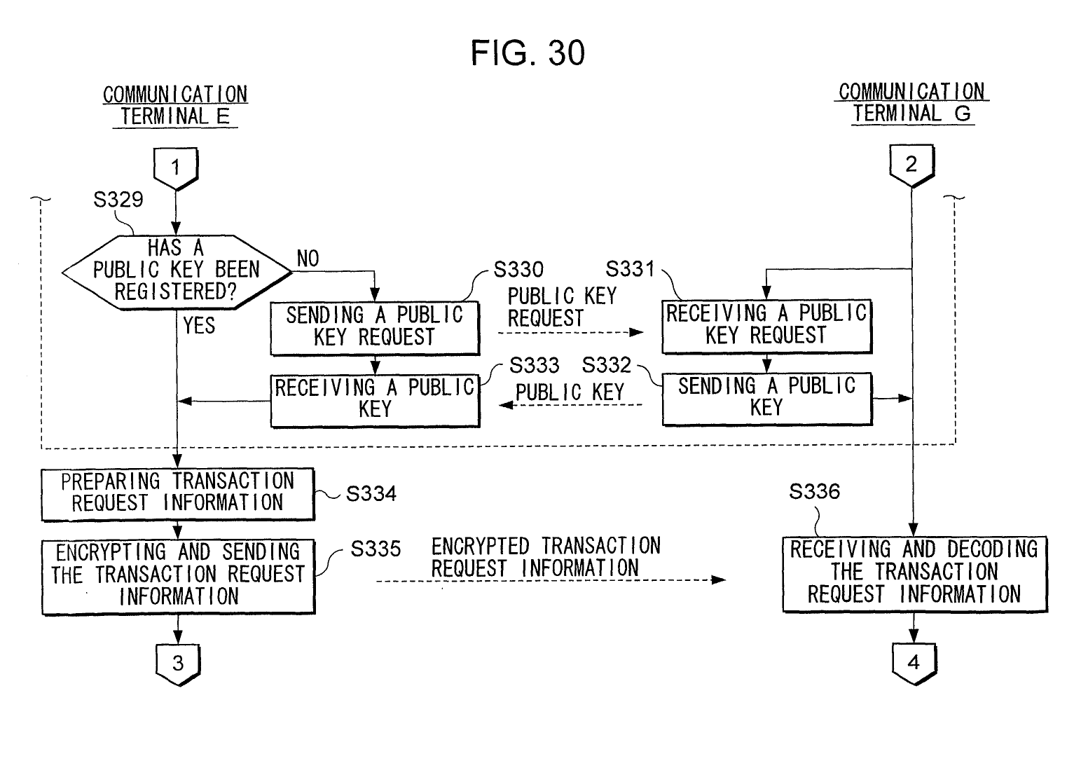

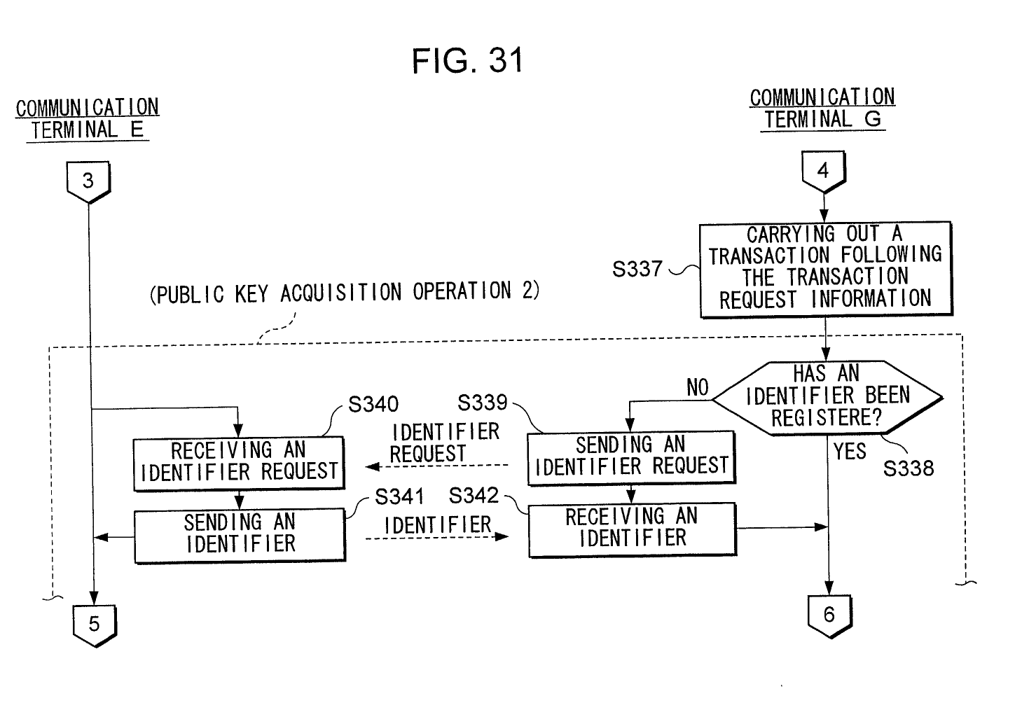

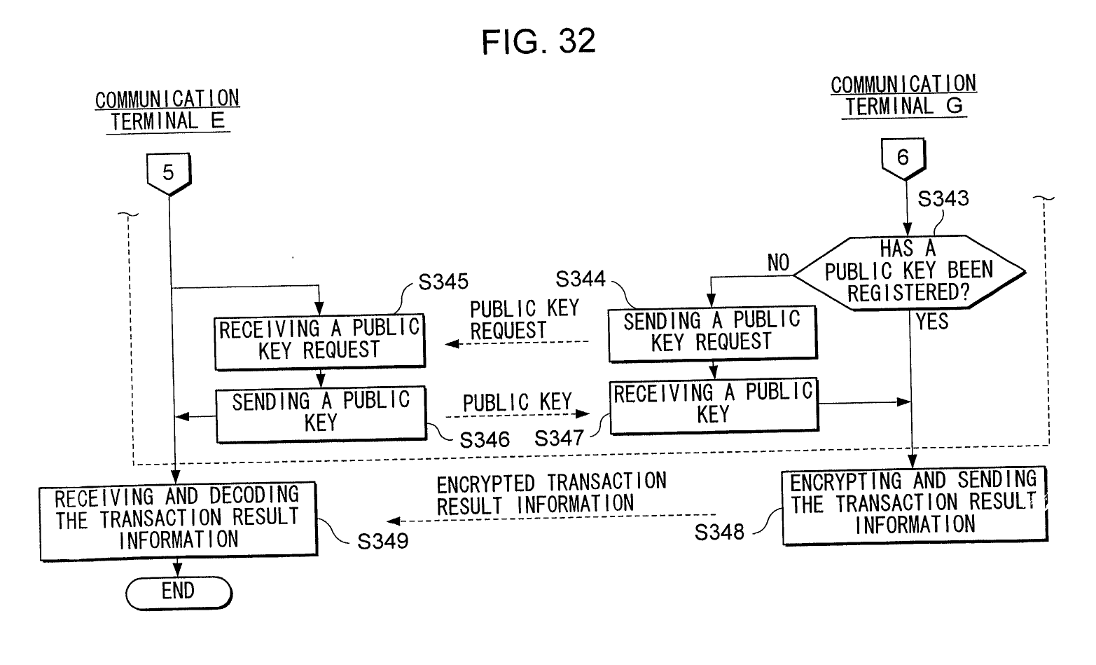

After completion of communication parameter setting explained above, when communication terminal E 5 performs wireless communication with other communication terminals in wireless LAN system 3, they encrypt and decode the communicated information using their public cryptograph keys and private cryptograph keys. Referring to FIGS. 29 and 30, the communication operation will now be explained. In the following explanation, communication terminal E 5 communicates with communication terminal G 7 and explanation of operations with other communication terminals is omitted since the operations with other communication terminals are the same as in the operation with communication terminal G 7. Moreover, the functions of communication terminal E 5 and communication terminal G 7 in the following explanation are interchangeable with each other. In the following operation, all communication between communication terminal E 5 and communication terminal G 7 is carried out through wireless communication unit 28E and wireless communication unit 34G.

Here, as an example, communication terminal E 5 requests communication terminal G 7 to perform a transaction. First, control unit 31E of communication terminal E 5 reads out identifier information file 326E, and judges if the MAC address field of any record of the file has the same value as the MAC address of the receiver, communication terminal G 7 (referred to as “MAC-G” hereafter) (FIG. 29, Step S324). In the case that the MAC address field of any record of the file has the same value as MAC-G, control unit 31E obtains “Yes” as a result of the judgment at Step S324. In the case that the MAC address field of any record of the file does not have the same value as MAC-G, control unit 31E obtains “No” as a result of the judgment at Step S324.

If control unit 31E obtains “Yes” at Step S324, it moves to Step S329 explained below.

If control unit 31E obtains “No” at Step S324, it sends an identifier request to communication terminal G 7 (Step S325), and control unit 37G receives the identifier request from communication terminal E 5 (Step S326).

Control unit 37G reads out setting management information file 381G, and sends the identifier item value of the file (referred to as “ID-G” hereafter) to communication terminal E 5 (Step S327). After control unit 31E receives ID-G from communication terminal G 7, it reads out identifier information file 326E, adds a new record to the file, and places MAC-G and ID-G in the MAC address field and in the identifier field of the new record, respectively (Step S328).

Next, control unit 31E reads out public key information file 327E, and judges if the identifier field value of any record of the file has the same value as ID-G (FIG. 30, Step S329). In the case that the identifier field value of any record of the file has the same value as ID-G, control unit 31E obtains “Yes” as a result of the judgment at Step S329. In the case that the identifier field value of any record of the file does not have the same value as ID-G, control unit 31E obtains “No” as a result of the judgment at Step S329.

If control unit 31E obtains “Yes” at Step S329, it moves to Step S334 explained below.

If control unit 31E obtains “No” at Step S329, it sends a public key request to communication terminal G 7 (Step S330), and control unit 37G receives the public key request from communication terminal E 5 (Step S331).

Control unit 37G reads out setting management information file 381G, and sends the public key item value (referred to as “Key-G” hereafter) to communication terminal E 5 (Step S332). After control unit 31E receives Key-G from communication terminal G 7, it reads out public key information file 327E, adds a new record to the file, and places ID-G and Key-G in the identifier field and in the public key field of the new record, respectively (Step S333). After Step S333, control unit 31E moves to Step S334 explained below. Hereafter, the series of operations described in Step S324 to Step 333 explained above will be referred to as “public key acquisition operation 1”.

After the public key acquisition operation 1, control unit 31E prepares transaction request information which is to be sent to communication terminal G 7. The transaction request information contains necessary data for the transaction in addition to a request message of the transaction to communication terminal G 7 (Step S334). Then control unit 31E encrypts the transaction request information using Key-G and sends the encrypted transaction request information to communication terminal G 7 (Step S335).

When control unit 37G of communication terminal G 7 receives the encrypted transaction request information, it reads out setting management information file 321F, and decodes the encrypted transaction request information using the private key item value of the file (Step S336).

Control unit 37G carries out the transaction following the decoded transaction request information, and stores the transaction result information in work area 384G (FIG. 31, Step S337).

After Step S337, communication terminal E 5 and communication terminal G 7 perform a public key acquisition operation 2, which is the same kind of operation as the public key acquisition operation 1 (from Step S324 to Step S333) explained above (from Step S338 to Step S347). The public key acquisition operation 2 is the same operation as the public key acquisition operation 1 except that the role of communication terminal E 5 in the public key acquisition operation 1 is taken by communication terminal G 7 in the public key acquisition operation 2, and explanation is therefore omitted.

After completion of public key acquisition operation 2, control unit 37G reads out the transaction result information which it stored in work area 384 at Step S337. Then control unit 37G reads out public key information file 383G, retrieves from the file, a record which has an identifier field value which is the same as a MAC address of communication terminal E 5 (referred to as “MAC-E” hereafter), and obtains a public key field value of the retrieved record (referred to as “Key-E” hereafter). Control unit 37G encrypts the transaction result information using Key-E, and sends the encrypted information to communication terminal E 5 (Step S348).

When control unit 31E of communication terminal E 5 receives the encrypted transaction result information, it reads out setting management information file 321E, and decodes the encrypted transaction result information using the private key item value of the file (Step S349). By the operation explained above, control unit 31E receives a result of the transaction which it requested from communication terminal G 7.

[3.3] Advantages of the Third Embodiment

In the third embodiment, a user of a communication terminal, which is newly connected to the wireless LAN, can carry out parameter setting for wireless communication by simply connecting with a data cable his/her communication terminal to one of the other communication terminals in the wireless LAN. Moreover, there is no need to start any application software to perform parameter setting. As will be obvious, communication parameter setting can thereby be easily carried out by any user.

In the third embodiment, users of communication terminals need only input their pre-registered passwords in a communication parameter setting operation. Additionally, in communication parameter setting, several communication protocols are selected, and the communication terminal newly connected to the wireless LAN can communicate with many communication terminals in the wireless LAN, without the need of an access point for relaying communication in the wireless LAN system.

In wireless LAN system 3, according to the third embodiment of the present invention, information exchanged between communication terminals is encrypted, and therefore protected from unauthorized access. Most wireless communication protocols utilize their own rules to encrypt designated information to be communicated. However, it may not be apparent to a user of a communication terminal newly connected to a wireless LAN system whether encryption is actually being employed, and regardless of whether or not a use of encryption is apparent to the user, it remains difficult for him or her to change settings of a wireless LAN which is already operating. However, by using a communication parameter setting method according to the third embodiment of the present invention, since there is no need to make any changes to the wireless LAN system itself a user of a communication terminal newly connected to a LAN is able to always and easily use encryption.

[4] The Fourth Embodiment

[4.1] The Configuration of the Fourth Embodiment

[4.1.1] The Configuration of the LAN System

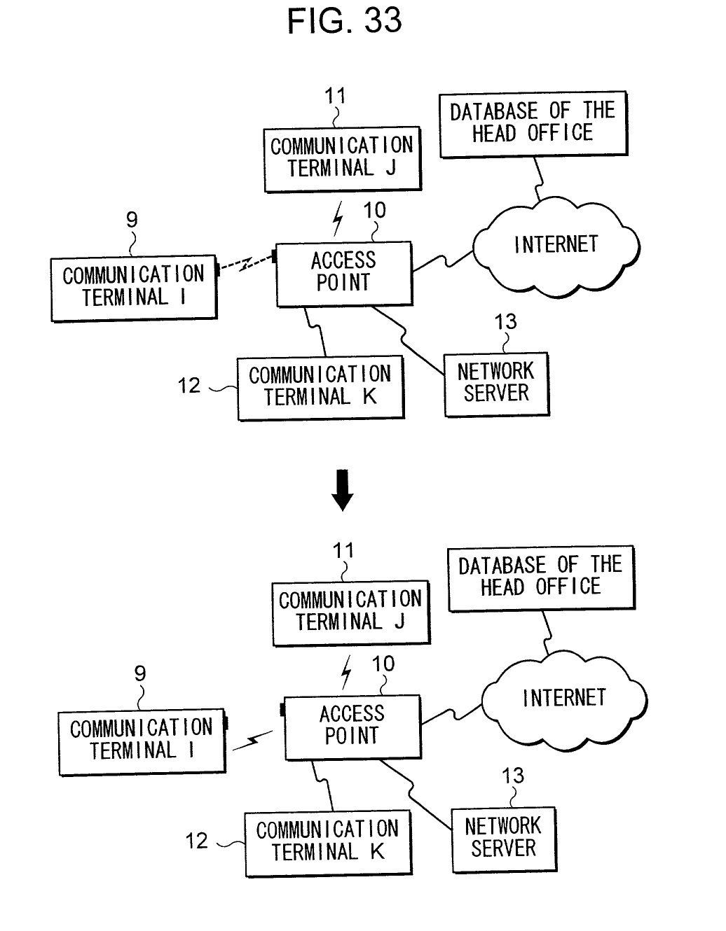

In the fourth embodiment of the present invention, a communication terminal newly connects to a LAN where several communication devices are already communicating with each other through an access point which relays communication. The newly connected communication terminal is enabled to communicate with the other communication devices connected to the access point. FIG. 33 shows a state of the LAN system in the communication parameter setting stage, and a state after the communication parameter setting in the fourth embodiment. Hereafter, the LAN system which is realized after the communication parameter setting in the fourth embodiment of the present invention will be referred to as “LAN system 4”.

In the fourth embodiment, there is provided an access point 10 which relays communication, and is connected to a communication terminal J 11 by wireless communication. Access point 10 is also connected to a communication terminal K12 and a network server 13 by wired communication. Moreover, access point 10 can connect over the Internet to a database in a distant head office, as required. Access point 10 is also connected to peripheral equipment such as printers (not shown) and scanners (not shown).

The LAN of this embodiment is already functioning. A communication terminal I 9 is newly connected to the LAN by using infrared to connect communication terminal I 9 to access point 10. Communication parameter setting is carried out in communication terminal I 9, to enable it to communicate with communication terminal J 11, the communication terminal H12, the Internet, and any peripheral equipment such as printers and scanners.

In the fourth embodiment, communication terminal I 9 makes a request for communication parameters for communication in LAN system 4, and access point 10 determines and sends them to communication terminal I 9. When communication terminal I 9 receives communication parameters from access point 10, it changes its communication parameters to those received. In the third embodiment, similar to the second embodiment and the third embodiment, parameters related to communication protocols in middle layers, such as TCP/IP, and so on, are also set.

Here, as an example, it is supposed that the LAN system in the fourth embodiment belongs to Company-A, Branch-B, Section-C. The database in the head office of Company-A stores identifiers of all communication devices of Company-A with names of sections to which they belong, and information in the database is continuously updated.

In all LANs of the head office and all branches of Company-A, in each network resource, including, for example, shared folders, shared printers, and so on, particular access rights are made available to an account group, depending on its status in the network; and network server 13 manages the access rights. Account groups have “Same Branch Same Section”, “Same Branch Different Section”, and “Different Branch”. Access rights have “Full Access”, which approves reading, editing, and deleting contents of the resources, “Read Only”, which approves only reading contents of the resource, and “Access Rejection”, which rejects using any contents of the resources. Also, for example, a shared folder may give Full Access to user accounts in Same Branch Same Section, Read Only to user accounts in Same Branch Different Section, and Access Rejection to user accounts in Different Branch.

Access Point 10 is connected to network server 13 by wired communication, and logs on to the LAN of the fourth embodiment three different user accounts at the same time. One of the user accounts is a user account in Same Branch Same Section (referred to as “Account P1” hereafter), another is a user account in Same Branch Different Section (referred to as “Account P2” hereafter), and the other is a user account in Different Branch (referred to as “Account P3” hereafter).

[4.1.2] The Configuration of the Communication Devices

[4.1.2.1] The Configuration of the Communication Terminal Newly Connected

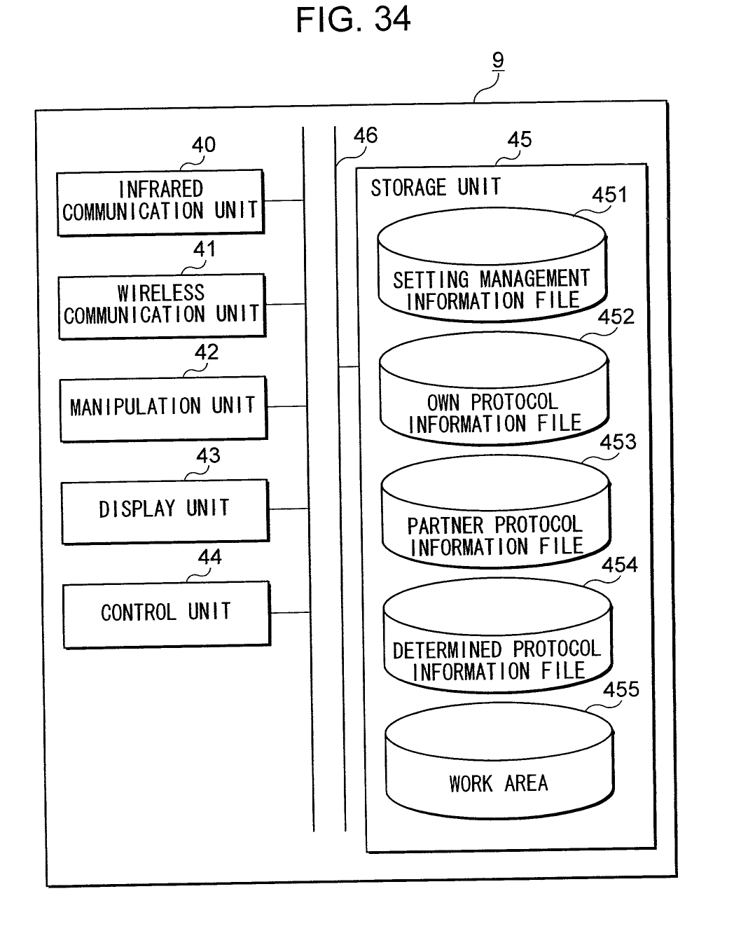

Next, referring to FIG. 34, the configuration of communication terminal I 9, which is to be newly connected to the LAN of the fourth embodiment, will now be explained.

Communication terminal I 9 has an infrared communication unit 40, a wireless communication unit 41, a manipulation unit 42, a display unit 43, a control unit 44, and a storage unit 45. All of these components are electrically connected to each other through a bus 46.

The functions and the configurations of wireless communication unit 41, manipulation unit 42, display unit 43, and control unit 44 are the same as those of wireless communication unit 21, manipulation unit 22, display unit 23, and control unit 24 of communication terminal C 3 in the second embodiment, respectively, and explanation of them is therefore omitted. The function of storage unit 45 is also the same as that of storage unit 25 of communication terminal C 3 in the second embodiment, and explanation is therefore also omitted.

Infrared communication unit 40 is connected to an infrared communication unit of the same type by infrared, whereby electric signals which contain parameter information and so on are sent and received under control of control unit 44. Infrared communication unit 40 has an antenna (not shown), and it demodulates received signals into base band signals, which signals contain text and picture data, and so on, and are sent via the antenna to control unit 44. Infrared communication unit 40 also receives base band signals from control unit 44, and the resulting carrier signals are modulated on the basis of the base band signals, and sent via the antenna to the outside. Communication devices which have infrared communication units of the same type as infrared communication unit 40 share a single communication protocol, and communication terminal I 9 sends and receives information through infrared communication unit 40 by way of the communication protocol.

Storage unit 45 stores a setting management information file 451, an own protocol information file 452, a partner protocol information file 453, and a determined protocol information file 454, and it has a work area 455.

The configurations of own protocol information file 452, partner protocol information file 453, determined protocol information file 454, and work area 455 are the same as those of own protocol information file 253, partner protocol information file 254, determined protocol information file 255, and work area 256 of communication terminal C 3 in the second embodiment, respectively, and explanation of them is therefore omitted.

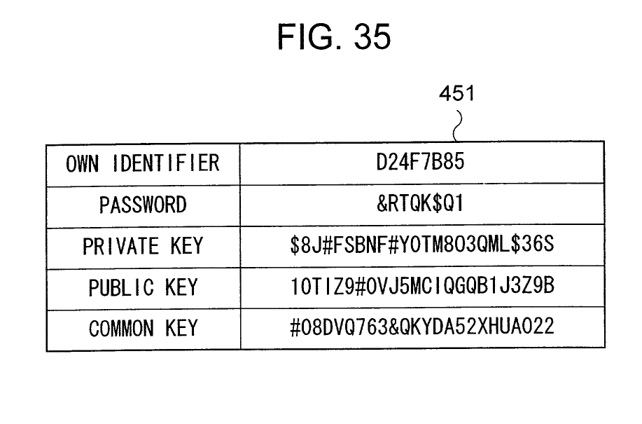

FIG. 35 shows the configuration of setting management information file 451. Setting management information file 451 has an own identifier item, a password item, a private key item, a public key item, and a common key item. The functions of the own identifier item and the password item are the same as those of setting management information file 251 of communication terminal C 3 in the second embodiment. The private key item contains information on a cryptograph key by use of which communication terminal I 9 decodes encrypted information which communication terminal I 9 receives from access point 10 in a communication parameter setting stage. The public key item contains information on a cryptograph key by use of which communication terminal I 9 encrypts information which access point 10 sends to communication terminal I 9 in a communication parameter setting stage. Values of the private key item and the public key item make a pair, and information which is encrypted using the public key item value can be decoded using the private key item value. The common key item contains information on a cryptograph key by use of which communication terminal I 9 encrypts and decodes information which communication terminal I 9 communicates with other communication devices in LAN system 4 via access point 10.

[4.1.2.2] Configuration of Access Point

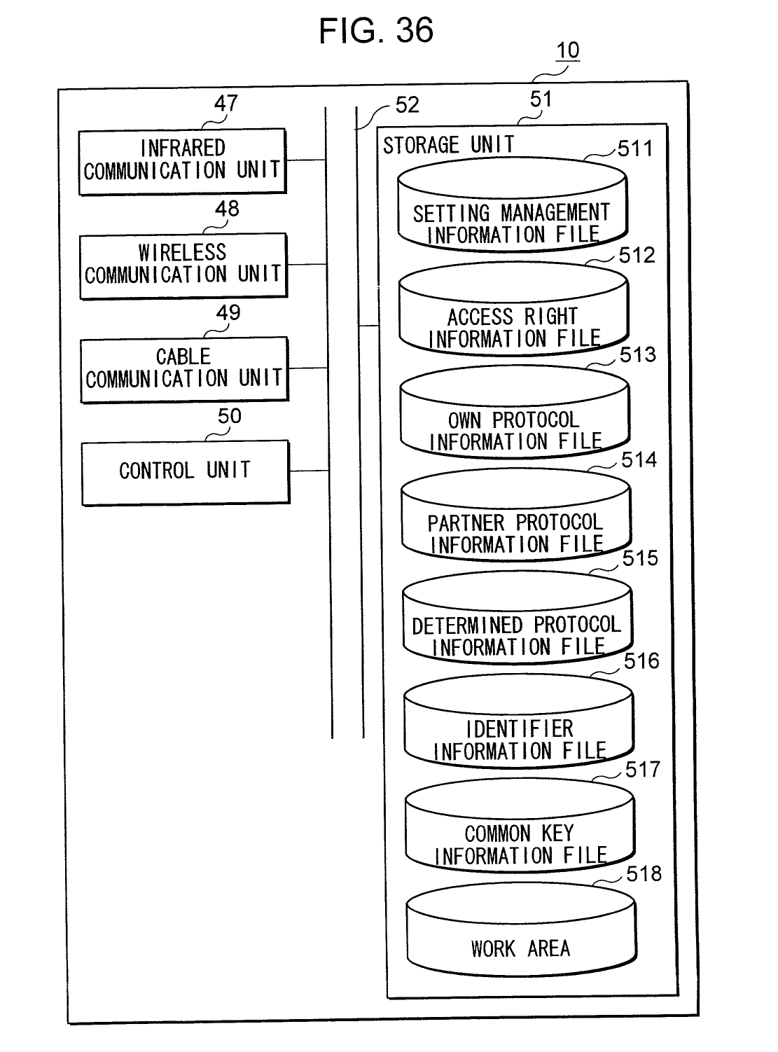

Referring to FIG. 36, the configuration of access point 10, which relays wireless communication in the fourth embodiment, will now be explained. Access point 10 has an infrared communication unit 47, a wireless communication unit 48, a cable communication unit 49, a control unit 50, and a storage unit 51. These components are electrically connected to each other through a bus 52.

The function and configuration of infrared communication unit 47 are the same as those of infrared communication unit 40 of communication terminal I 9, and explanation of them is therefore omitted. The function and configuration of wireless communication unit 48 are the same as those of wireless communication unit 21 of communication terminal C 3 in the second embodiment, and thus explanation of them is also omitted. Moreover, the function of storage unit 51 is the same as that of storage unit 25 of communication terminal C 3 in the second embodiment, and explanation of it is also omitted.

Cable communication unit 49 is connected to cable communication units of the same type by LAN cables, optical cables, and so on, and it sends and receives data when access point 10 performs wired communication with other communication devices. When cable communication unit 49 receives electric signals or optical signals from the outside, it converts them into electric signals which control unit 50 can read, and transfers them to control unit 50. When cable communication unit 49 receives electric signals from control unit 50, it converts them into electric signals or optical signals which other communication devices outside can read, and transfers them to the outside devices.

The configuration of control unit 50 is the same as that of control unit 24 of communication terminal C 3 in the second embodiment, but control unit 50 also has a function to record history of data volume which communicated through wireless communication unit 48, estimates throughput of each communication protocol set using the history, and puts higher priority to protocol set with larger throughput. When the priority changes, control unit 50 reads out own protocol information file 513, which is explained below, and updates the priority field value of the file with positive integers which show new priority information.

Storage unit 51 stores a setting management information file 511, an access right information file 512, an own protocol information file 513, a partner protocol information file 514, a determined protocol information file 515, an identifier information file 516, and a common key information file 517,and it has a work area 518.

The configurations of own protocol information file 513, partner protocol information file 514, determined protocol information file 515, and work area 518 are the same as those of own protocol information file 253, partner protocol information file 254, determined protocol information file 255, and work area 256 of communication terminal C 3 in the second embodiment, respectively, and explanation of them is therefore omitted. The configuration of identifier information file 516 is also the same as that of identifier information file 326 of communication terminal E 5 in the third embodiment, and explanation of them is also omitted.

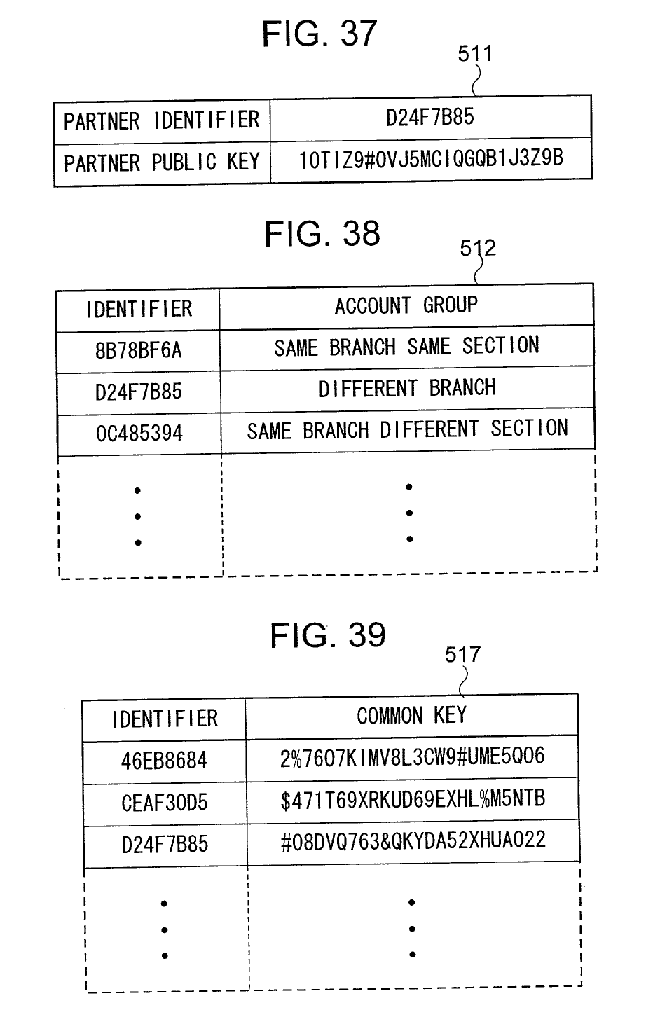

FIG. 37 shows the configuration of setting management information file 511. Setting management information file 511 has a partner identifier item and a partner public key item. The partner identifier item contains an identifier of a communication terminal which is newly connected to the LAN through access point 10. The partner public key item contains information on a cryptograph key by use of which access point 10 encrypts information which access point 10 sends to the communication terminal newly connected to the LAN through access point 10, in the communication parameter setting stage.

FIG. 38 shows the configuration of access right information file 512. Access right information file 512 contains records on communication devices which are registered in the database in the head office of Company-A, and each record is a set of information on one of the communication devices. Each record has an identifier field and an account group field. The identifier field contains an identifier of a target communication device, and the account group field contains information on account group to which the target communication device belongs in Company-A, Branch-B, Section-C. Access point 10 periodically downloads from the database in the head office, over the Internet, identifiers and names of sections, to which the communication devices belong. Then access point 10 reads a name of a section one at a time from the downloaded information, and replaces the name with “Same Branch Same Section” if the name shows Company-A, Branch-B, Section-C; replaces the name with “Same Branch Different Section” if the name shows any other section than Section-C in Company-A, Branch-B; and replaces the name with “Different Branch” if the name shows any other branch than Branch-B in Company-A. After this, access point 10 updates the identifier field values with the downloaded identifiers, and the account group field values with the replaced information, which show account groups of communication devices.

FIG. 39 shows the configuration of common key information file 517. Common key information file 517 contains records on communication devices which have previously been connected to access point 10. Each record has an identifier field and a common key field. The identifier field contains an identifier of a target communication device, and the common key field contains a information on a cryptograph key by use of which access point 10 encrypts and decodes information when access point 10 communicates with the target communication device using wireless communication unit 48 or cable communication unit 49.

Access point 10 does not have a manipulation unit nor a display unit, but administrators of access point 10 can manipulate access point 10 through other communication devices using infrared communication unit 47, wireless communication unit 48, or cable communication unit 49.

[4.1.2.3] The Configuration of Communication Terminals Other Than the Communication Terminal Newly Connected

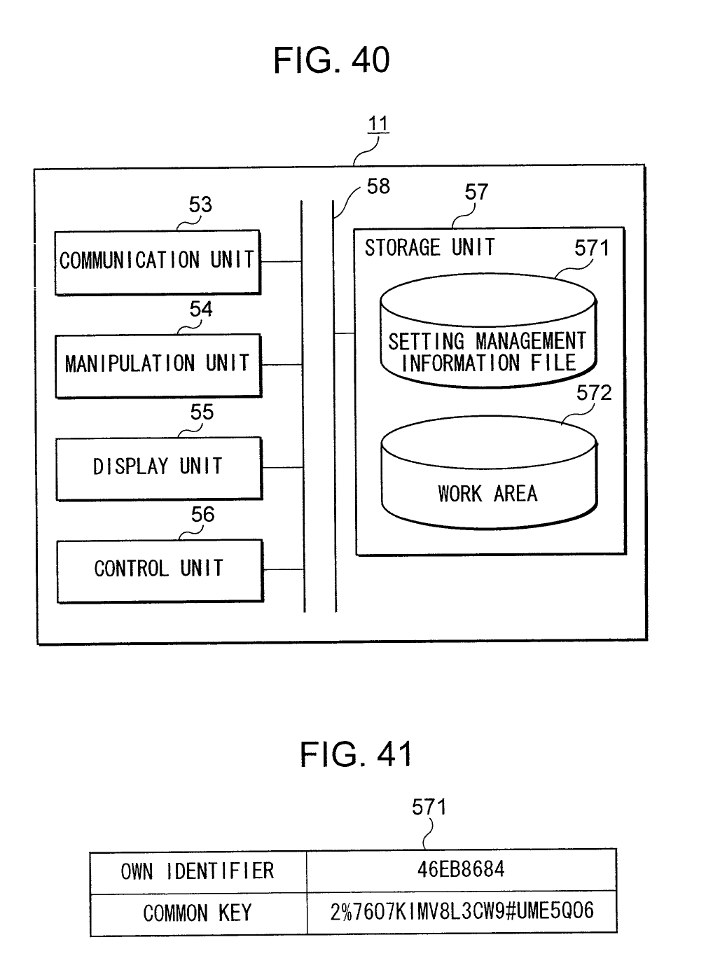

In the fourth embodiment, the configurations of communication terminals, which are not newly connected to the LAN, are the same. Therefore, explanation of the configuration of communication terminal J 11 is provided below referring to FIG. 40, and explanation of the configuration of communication terminal K 12 is therefore omitted.

Communication terminal J 11 has a communication unit 53, a manipulation unit 54, a display unit 55, a control unit 56, and a storage unit 57. All of the components are electrically connected to each other through a bus 58.

The functions and the configurations of manipulation unit 54, display unit 55, and control unit 56 are the same as those of manipulation unit 22, display unit 23, and control unit 24 of communication terminal C 3 in the second embodiment, respectively, and thus explanation of them is omitted. The function of storage unit 57 is the same as that of storage unit 25 of communication terminal C 3 in the second embodiment, and thus explanation of it is also omitted.

Communication unit 53 is connected to communication units of the same type by cables or radio wave, and it sends and receives data when communication unit 53 communicates with other communication devices. When communication unit 53 receives electric signals, optical signals, or radio wave signals from the outside, it converts them into electric signals which control unit 56 can read, and transfers them to control unit 56. When communication unit 53 receives these electric signals from control unit 56, it converts them into electric signals, optical signals, or radio wave signals which other communication devices outside can read, and transfers the converted signals to the outside devices.

Storage unit 57 stores a setting management information file 571, and it has a work area 572.

The function of work area 572 is the same as that of work area 256 of communication terminal C 3 in the second embodiment, and explanation of it is omitted.

FIG. 41 shows the configuration of setting management information file 571. Setting management information file 571 has an own identifier item and a common key item. The function of own identifier item is the same as that of setting management information file 251 of communication terminal C 3 in the second embodiment. The common key item contains information on a cryptograph key by use of which communication terminal J 11 encrypts and decodes information when communication terminal J 11 communicates with access point 10 using communication unit 53.

[4.2] The Operation of the Fourth Embodiment

The communication parameter setting operation for LAN system 4 in the fourth embodiment, and the communication operation performed after the communication parameter setting will now be described. Hereafter, to distinguish like components of communication terminal I 9 and access point 10, the letters “I” and “P” are placed, respectively, after numerals denoting like corresponding components.

[4.2.1] The Connection Authentication and Parameter Setting Stage

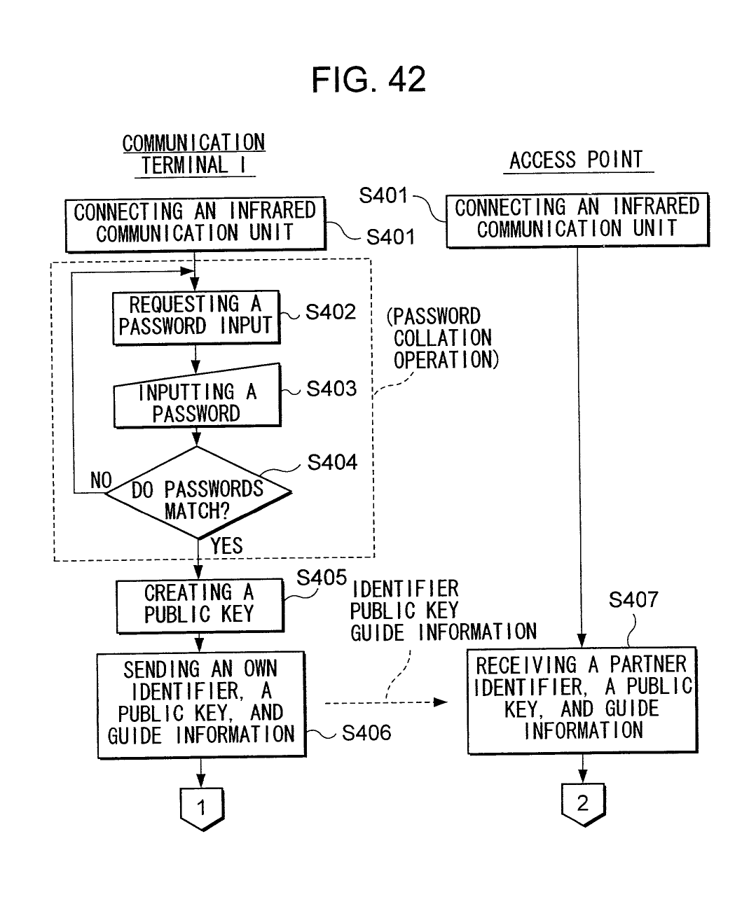

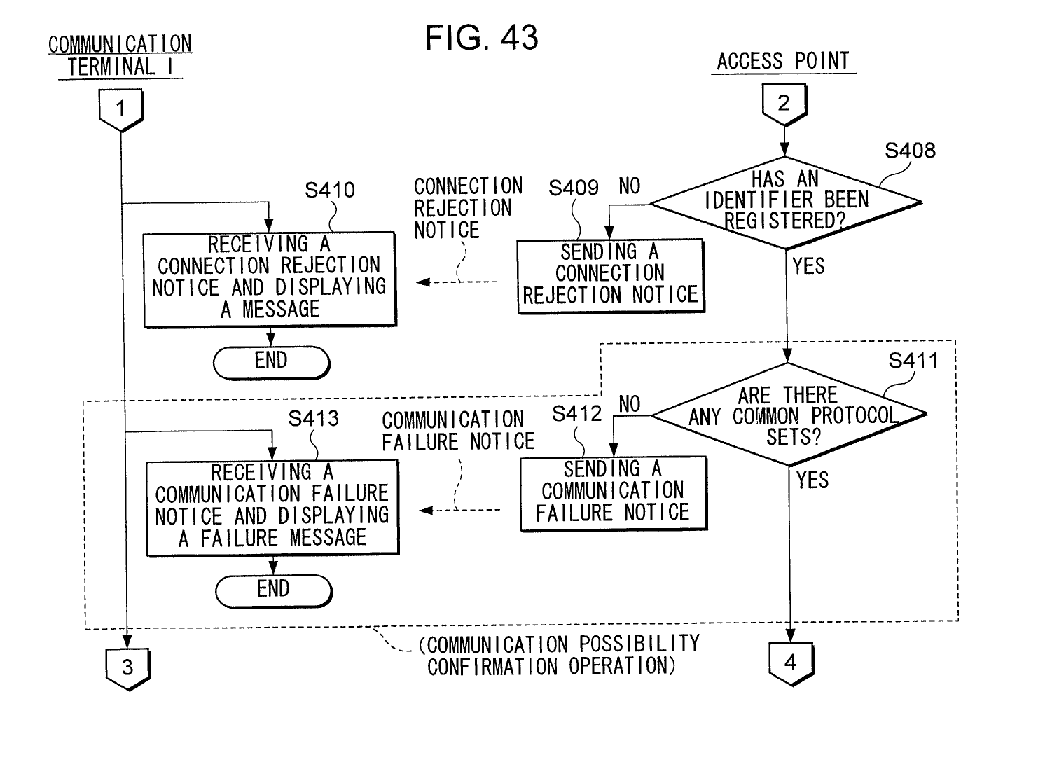

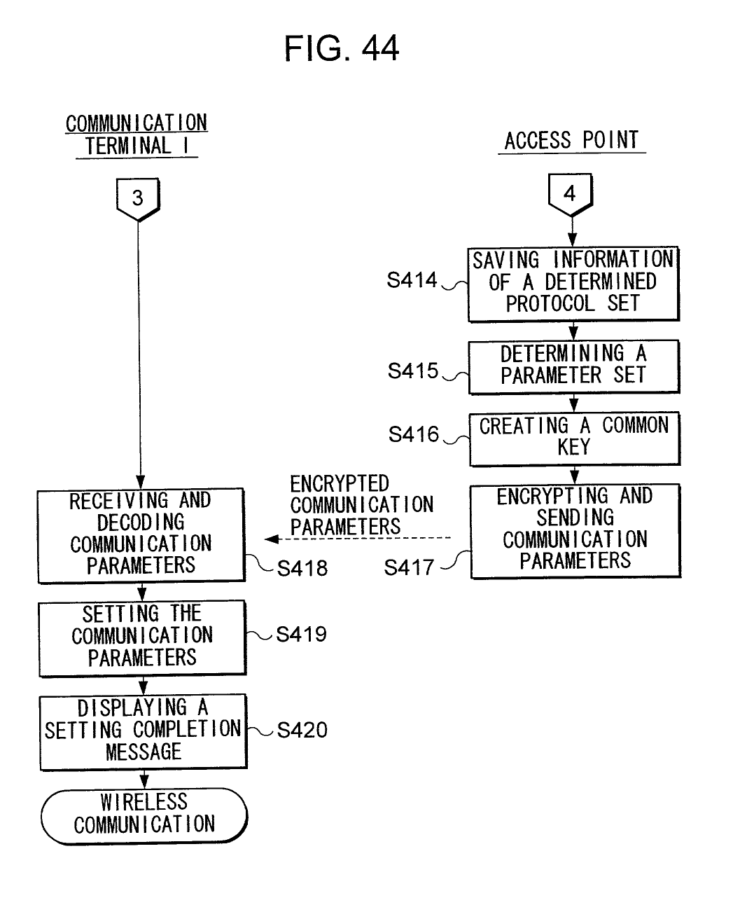

First, access point 10 authenticates a connection of communication terminal I 9 to access point 10. Then access point 10 determines communication parameters which are required for communication terminal I 9 to perform wireless communication in LAN system 4, and communication terminal I 9 changes its communication parameters to those which access point 10 determined. Explanation of its operation will now be made with reference to FIG. 42, FIG. 43, and FIG. 44.

In the following operation of the connection authentication and parameter setting stage, infrared communication unit 401 and infrared communication unit 47P are used for all communication between communication terminal I 9 and access point 10.

First, a user of communication terminal I 9 places communication terminal I 9 in a position at which infrared communication unit 47P of access point 10 is visible. Infrared communication unit 401 and communication unit 47P detect infrared ray signals sent from the partner device, and establish an infrared connection (FIG. 42, Step S401).

Next, control unit 44I performs a password collation operation. The password collation operation here is the same as the series of operations described in Step S206 to Step S208 of the second embodiment, and explanation of it is omitted (from Step S402 to Step S404). Password input is an operation used to confirm that an authorized user is trying to connect communication terminal I 9 to the LAN.

In the case that the two passwords match at Step 404, control unit 44I creates a private key and public key pair, reads out setting management information file 451I, and updates the private key item value and the public key item value with the created private key and the created public key, respectively. There are several well known methods to create private key and public key pairs, and explanation of it is omitted.

Next, control unit 44I reads out setting management information file 451I and own protocol information file 452I, and first control unit 44I obtains the own identifier item value of setting management information file 451I (referred to as “ID-I” hereafter) and the public key item value of setting management information file 451I (referred to as “Key-I” hereafter). Then control unit 44I obtains the MAC address field values and the protocol set field values of all of the records of own protocol information file 452I (referred to as “Protocol Set Table I” hereafter), keeping their correspondences in each record. Protocol Set Table I functions as guide information for protocol set which communication terminal I 9 can use in communicating via wireless communication unit 41I. Then control unit 44I sends IE-I, Key-I, and Protocol Set Table I to access point 10 (Step S406).

After control unit 50P of access point 10 receives ID-I, Key-I, and Protocol Set Table I, it reads out setting management information file 511P and updates the partner identifier item value of the file with ID-I, the partner public key item value of the file with Key-I, respectively. Then control unit 50P reads out partner protocol information file 514P, and updates the MAC address field values and the protocol set field values of records of the file with the MAC address field values and the protocol set field values of records of Protocol Set Table I, respectively (Step S407).

Next, control unit 50P reads out access right information file 512P, and judges if the identifier field of any record of the file has the same value as ID-I (FIG. 43, Step S408). In the case that the identifier field of any record of the file has the same value as ID-I, control unit 50P obtains “Yes” as a result of the judgment at Step S408. In the case that the identifier field of any record of the file does not have the same value as ID-I, control unit 50P obtains “No” as a result of the judgment at Step S408.

In the case that control unit 50P obtains “Yes” at Step S408, it moves to Step S411 explained below.

In the case that control unit 50P obtains “No” at Step S408, it sends a connection rejection notice to communication terminal I 9 (Step S409). This means that communication terminal I 9 is not registered, and its request for connection to the LAN is rejected.

When control unit 44I of communication terminal I 9 receives the connection rejection notice from access point 10, it displays a message stating that the connection is rejected, by display unit 43I (Step S410). After this step, control unit 44I finishes its operation.

In the case that control unit 50P obtains “Yes” at Step S408, communication terminal I 9 and access point 10 perform a communication possibility confirmation operation. The communication possibility confirmation operation here is essentially the same as the series of operations described in Step S220 to Step S222 of the second embodiment, and thus detailed explanation of them is omitted (from Step S411 to Step S413). In the communication possibility confirmation operation, communication terminal I 9 and access point 10 function as the communication terminal S and the communication terminal M, respectively, in the second embodiment. However, control unit 50P does not display a message stating that setting for the wireless communication cannot be executed.

In the case that control unit 50P obtains “Yes” as a result of the judgment at Step S411, control unit 50P reads out own protocol information file 513P and partner protocol information file 514P. Then control unit 50P extracts from the records of own protocol information file 513P, any which has a protocol set field value which is the same as a protocol set field value of a record of partner protocol information file 514P. In the case that several records are extracted from own protocol information file 513P, control unit 50P compares priority field values of the records, and selects that which has the lowest priority field value. In the case that only one record is extracted from the file, control unit 50P selects that record. Then control unit 50P reads out determined protocol information file 515P, and updates the own MAC address field value of the one record of the file with the MAC address field value of the selected record (referred to as “MAC-P” hereafter), and the protocol set field value of the one record of the file with the protocol set field value of the selected record (referred to as “Determined Protocol Set 4” hereafter), respectively. Then control unit 50P retrieves from partner protocol information file 514P, a record which has a protocol set field value which is the same as Determined Protocol Set 4, and updates the partner MAC address field value of the one record of Determined Protocol Information File 515P with the MAC address field value of the retrieved record (referred to as “MAC-I” hereafter) (FIG. 44, Step S414).

Next, control unit 50P determines, on the basis of the parameter set field values of the record of own protocol information file 513P which is selected at Step S414, communication parameters which are required to be changed to enable communication terminal I 9 to perform wireless communication with access point 10 using the protocol set which Determined Protocol Set 4 shows. Hereafter, the parameter set for communication terminal I 9 will be referred to as “Parameter Set I”. Then control unit 50P reads out determined protocol information file 515P, and updates the parameter set field values of the one record of the file with Parameter Set I (Step S415). The method of determining the parameter set is the same as that in the second embodiment and the third embodiment, and thus explanation of it is omitted here.

Next, control unit 50P creates an arbitrary cryptograph key (referred to as “Key′-I” hereafter) which is used for encrypting and decoding information when communication terminal I 9 and access point 10 communicate with each other using wireless communication unit 41I and wireless communication unit 48P. Cryptograph keys are combinations of figures, letters, and symbols, and they are created by functions which can create random numbers. There are many well known methods to create random numbers, and the explanation of them are omitted. Next, control unit 50P reads out setting management information file 511P, and obtains the partner identifier item value, namely ID-I. Then control unit 50P reads out common key information file 517P, retrieves from the file a record which has an identifier field value which is the same as ID-I, and updates the common key field value of the retrieved record with Key′-I. In the case that the common key field value of any record of common key information file 517P is not the same as ID-I, control unit 50P adds a new record to the file, and places ID-I in the identifier field of the new record, and Key′-I in the common key field of the new record, respectively (Step S416).

Next, control unit 50P reads out setting management information file 511P, and obtains the partner identifier item value, namely ID-I, and the partner public key item value, namely Key-I. Then control unit 50P reads out common key information file 517P, retrieves from the file a record which has an identifier field value which is the same as ID-I, and obtains the common key field value of the retrieved record, namely Key′-I. Then control unit 50P reads out determined protocol information file 515P, and obtains the own MAC address field value of the one record of the file, namely MAC-P, the protocol set field value of the one record, namely Determined Protocol Set 4, and the parameter set field values of the one record, namely Parameter Set I. This information consists of communication parameters which enable communication terminal I 9 to perform wireless communication with access point 10 using wireless communication unit 41I. Then control unit 50P encrypts MAC-P, Determined Protocol Set 4, Parameter Set I, and Key′-I using Key-I, and sends the encrypted information to communication terminal I 9 (Step S417).

After control unit 44I of communication terminal I 9 receives the encrypted information which contains MAC-P, Determined Protocol Set 4, Parameter Set I, and Key′-I, it reads out setting management information file 451I, and decodes the received information using the private key item value of the file, namely Key-I. Then control unit 44I reads out determined protocol information file 454I, and updates the partner MAC address field value, the protocol set field value, and the parameter set field value of the one record of the file with MAC-P, Determined Protocol Set 4, and Parameter Set I, respectively. Next, control unit 44I reads out own protocol information file 452I, and retrieves from the file a record which has a protocol set field value which is the same as Determined Protocol Set 4. Then control unit 44I updates the own MAC address value of the one record of determined protocol information file 454I with the MAC address field value of the retrieved record, namely MAC-I. Then control unit 44I reads out setting management information file 451I, and updates the common key item value with Key′-I (Step S418).

Control unit 44I reads out determined protocol information file 454I, and sends the protocol set field value and the parameter set field value of the one record of the file to wireless communication unit 41I. After wireless communication unit 41I receives this information, it changes its communication parameters for the communication protocol set, which corresponds to the protocol set field value, to those corresponding to the parameter set field values. When wireless communication unit 41I completes this change setting of communication parameters, it sends a notice of completion of setting to control unit 44I (Step S419).

After control unit 44I receives the notice of completion of setting from wireless communication unit 41I, it displays a message stating that the setting for wireless communication is completed, by display unit 43I (Step S420).

After the user of communication terminal I 9 is informed by the message that the parameter setting for wireless communication have been completed, the user can release the connection between communication terminal I 9 and access point 10 through infrared communication unit 40I and infrared communication unit 47P. Communication terminal I 9 is then able to perform wireless communication with other communication terminals through access point 10, using protocol set which Determined Protocol Set 4 shows.

[4.2.2] The Method of Communication using Common Keys

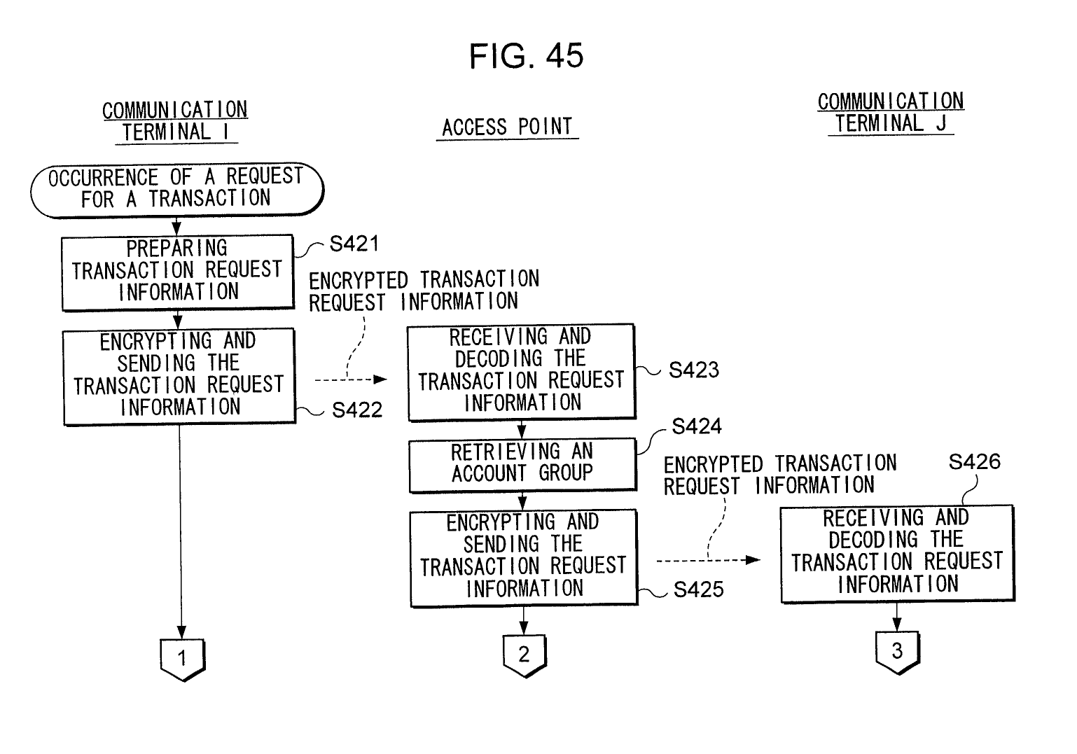

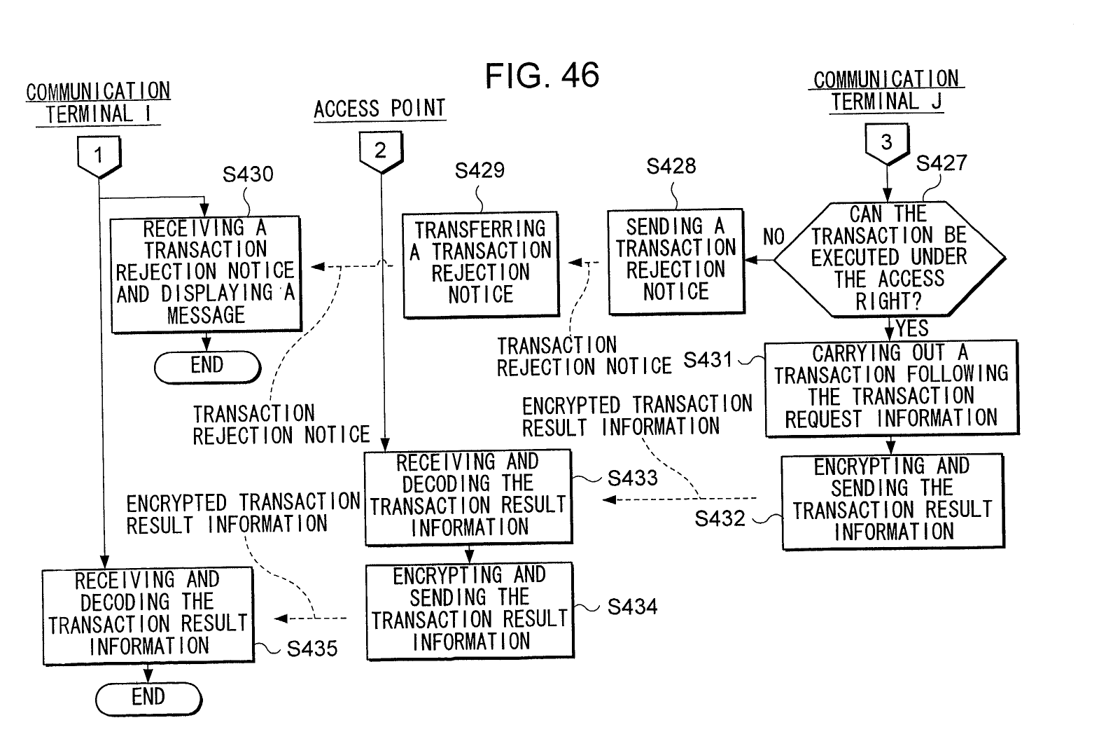

After the communication parameter setting is carried out as explained above, when communication terminal I 9 performs wireless communication with other communication terminals in LAN system 4, communicated information is encrypted using common cryptograph keys of the communication terminals. Moreover, when communication terminal I 9 needs to use the network resources, access point 10 accesses the resources as a proxy of communitarian terminal I 9, whereby access point 10 enables network server 13 to manage access rights of communication terminal I 9 in LAN system 4. These operations are explained with reference to FIG. 45 and FIG. 46. The following explanation is an example case where communication terminal I 9 requests a transaction to communication terminal J 11 through access point 10. For the sake of explanation, it is supposed that communication terminal I 9 belongs to Company-A, Branch-D, Section-E. In the following explanation, to distinguish like components of communication terminal I 9, access point 10, and communication terminal J 11, the letters “I”, “P”, and “J” are placed, respectively, after numerals denoting like corresponding components.

In the following operation, wireless communication unit 411 and wireless communication unit 48P are used for all communication between 83 communication terminal I 9 and access point 10, and wireless communication unit 48P or cable communication unit 49P, and Communication Unit 53J are used for all communication between access point 10 and communication terminal J 11.

First, control unit 44I prepares transaction request information for communication terminal J 11 (FIG. 45, Step S421). The transaction request information contains necessary data for the transaction in addition to the MAC address of communication terminal J 11 (referred to as “MAC-J” hereafter) and a request message of the transaction to communication terminal J 11.

Next, control unit 44I reads out setting management information file 451I, obtains the common key item value of the file, namely Key′-I, and encrypts the transaction request information using Key′-I. Then control unit 44I reads out determined protocol information file 454I, obtains the own MAC address field value of the one record of the file, namely MAC-I, attaches MAC-I to the encrypted transaction request information, and sends it to access point 10 (Step S422).

When control unit 50P of access point 10 receives the encrypted transaction request information with MAC-I, it reads out identifier information file 516P, retrieves from the file a record which has a MAC address field value which is the same as MAC-I, and obtains the identifier field value of the retrieved record, namely ID-I. Then control unit 50P reads out common key information file 517P, retrieves from the file a record which has an identifier field value which is the same as ID-I, and obtains the common key field value of the retrieved record, namely Key′-I. Control unit 50P decodes the encrypted transaction request information using Key′-I. Then control unit 50P stores the transaction request information with Key′-I in work area 518P (Step S423).

Next, control unit 50P reads out access right information file 512P, retrieves from the file a record which has an identifier field value which is the same as ID-I, which it obtained at Step S423, and obtains the account group field value of the retrieved record (Step S424). Since the LAN system in the fourth embodiment belongs to Company-A, Branch-B, Section-C and communication terminal I 9 belongs to Company-A, Branch-D, Section-E, the account group field value of the retrieved record is “Different Branch”.

Next, control unit 50P reads out the transaction request information from work area 518P, and obtains MAC-J as a MAC address of the receiver of the transaction request. Then control unit 50P reads out identifier information file 516P, and retrieves from the file a record which has a MAC address field value which is the same as MAC-J. Then control unit 50P reads out common key information file 517P, retrieves from the file a record which has an identifier field value which is the same as ID-J, and obtains the common key field value of the retrieved record (referred to as Key′-J hereafter). Control unit 50P encrypts the transaction request information using Key′-J. Then control unit 50P attaches “Account P3” to the encrypted transaction request information as user account information of the sender, and sends it to communication terminal J 11 (Step S425). As explained above, Account P3 is a user account utilized by access point 10 to log on to the LAN as a user in Different Branch group. Control unit 50P chose Account P3 because the user account corresponding to communication terminal J 11 is in Different Branch group.

When control unit 56J of communication terminal J 11 receives the encrypted transaction request information, it reads out setting management information file 571J, and decodes the encrypted transaction request information using the common key item value of the file, namely Key′-J (Step S426).

Control unit 56J carries out the transaction following the received transaction request information, and when control unit 56J needs to use any shared network resource in the LAN, it requests network server 13 to send access right information on the target network resources given to Account P3. Responding to the request, network server 13 sends the access right information to communication terminal J 11. Control unit 56J then judges if all operations required to be executed can be carried out under the access right given to Account P3 (FIG. 46, Step S427). If negative, control unit 56J stops the transaction and obtains “No” as a result of the judgment. If affirmative, control unit 56J obtains “Yes” as a result of the judgment.

In the case that control unit 56J obtain “No” at Step S427, it sends a transaction rejection notice to access point 10 (Step S428).

When control unit 50P of access point 10 receives the transaction rejection notice from communication terminal J 11, it transfers the notice to communication terminal I 9 (Step S429).

When control unit 44I of communication terminal I 9 receives the transaction rejection notice from access point 10, it displays a message on display unit 43I stating that the transaction is rejected (Step S430). After this step, control unit 44I finishes its operation.

In the case that control unit 56J obtains “Yes” at Step S427, it completes the requested transaction (Step S431).

After control unit 56J completes the requested transaction, it reads out setting management information file 571J, and encrypts the transaction result information using the common key field value of the file, namely Key′-J. Then control unit 56J attaches MAC-J, as the sender's MAC address, to the encrypted transaction result information, and sends it to access point 10 (Step S432).

When control unit 50P of access point 10 receives the encrypted transaction result information with MAC-J, it reads out identifier information file 516P, retrieves from the file a record which has a MAC address field value which is the same as MAC-J, and obtains the identifier field value of the retrieved record, namely ID-J. Then control unit 50P reads out common key information file 517P, retrieves from the file a record which has an identifier field value which is the same as ID-J, and obtains the common key field value of the retrieved record, namely Key′-J. Control unit 50P decodes the encrypted transaction result information using Key′-J (Step S433).

Next, control unit 50P reads out the transaction request information and Key′-I from work area 518P, which it stored at Step S423. Then control unit 50P verifies that the decoded transaction result information is the result for the transaction request information, and encrypts the transaction result information using Key′-I. Control unit 50P sends the encrypted transaction result information to communication terminal I 9 (Step S434).

When control unit 44I of communication terminal I 9 receives the encrypted transaction result information, it reads out setting management information file 451I, and decodes the encrypted transaction result information using the common key item value of the file, namely Key′-I (Step S435). By the operation explained above, control unit 44I receives the result of the transaction which it requested from communication terminal J 11.

[4.3] Advantages of the Fourth Embodiment

In the fourth embodiment, to newly connect a communication terminal to the wireless LAN, a user of the communication terminal needs only to place the communication terminal near the access point which relays communication in the LAN, and input a pre-registered password. Necessary communication parameter setting is then performed automatically. As will be obvious, automation of parameter setting enables efficient and easy operation of a communication terminal by a user. Moreover, since an infrared connection is used, which is a short range wireless connection, ease of connection between devices can be carried out even in the case that the devices can not be brought into actual physical contact with each other, and at the same time, unauthorized access to the LAN is difficult to be carried out.

In the fourth embodiment, in the communication parameter setting, a communication protocol estimated to have the highest throughput is selected from the available communication protocols. As a consequence, a highly efficient communication network is realized.

In the fourth embodiment, the access point authenticates, on the basis of the information of the section to which the communication terminal belongs, connection of a new communication terminal. By use of the system of the present invention, therefore, it is possible to readily prevent connection of any unauthorized communication terminals to the LAN.

LAN system 4, even in the case that information communicated between a communication terminal newly connected to the network and other network-connected communication devices is accessed by an unauthorized person, since the information is encrypted, it can not be abused. Common key cryptography is used to effect encryption, use of which enables rapid communication within the system. Further, by using the access point to centralize management of common keys for each communication device, administrator work load is reduced.

In LAN system 4, access to network resources by a communication terminal newly connected to the LAN is managed on the basis of information relating to the section to which the communication terminal belongs. In this way, it is not necessary to change settings of the existing LAN, thereby greatly reducing work involved in managing access rights to the LAN.

What is claimed is:

1. A method of setting communication parameters, said method comprising:
a connection step in which a first communication device is connected to a second communication device, each of which devices has a first communication unit for wireless communication, and a second, different, communication unit, said devices being connected in said connecting step via respective said second communication units;
a guide information communication step in which said first communication device sends, via its second communication unit, guide information which is received by said second communication device via its second communication unit, said guide information concerning communication forms usable by said first communication unit of said first communication device; and
a communication parameter determination step in which said second communication device determines on the basis of said guide information, communication parameters for use when said first communication device and said second communication device communicate via their respective first communication units.

2. The method according to claim 1, wherein following completion of said communication parameter determination step,
a communication parameter setting step is carried out in which said second communication device sets communication parameters determined in said communication parameter determination step, said communication parameters being used when said second communication device communicates with said first communication device via its first communication unit.

3. The method according to claim 1, wherein following completion of said communication parameter determination step,
a communication parameter communication step is carried out in which said second communication device sends, via its second communication unit, communication parameters determined in said communication parameter determination step, which communication parameters are received by said first communication device via its second communication unit; and
a communication parameter setting step is carried out in which said first communication device sets said communication parameters, said communication parameters being used when said first communication device communicates with said second communication device via its first communication unit.

4. The method according to claim 1, wherein following completion of said communication parameter determination step,
a communication parameter communication step is carried out in which said second communication device sends via its second communication unit, communication parameters determined in said communication parameter determination step, which communication parameters are received by said first communication device via its second communication unit; and
a communication parameter setting step is carried out in which said first communication device and said second communication device set said communication parameters, said communication parameters being used when said first communication device and said second communication device communicate via their respective first communication units.

5. The method according to claim 1, wherein the connection in said connection step is established by bringing into direct contact said second communication unit of said first communication device with said second communication unit of said second communication device.

6. The method according to claim 1, wherein the connection in said connection step is established by a shorter distance wireless communication than the wireless communication between said first communication device and said second communication device via respective said first communication units.

7. The method according to claim 1, wherein said first communication device and said second communication device are communication terminals.

8. The method according to claim 1, wherein either said first communication device or said second communication device is an access point for relaying communications when two or more other communication devices execute wireless communications.

9. The method according to claim 1 wherein, in said communication parameter determination step,
a communication protocol selection step is carried out in which said second communication device selects one or more communication protocols, said communication protocols being used when said second communication device communicates with said first communication device via its first communication unit.

10. The method according to claim 1, wherein said communication parameters include communication protocol parameters for use in performing both wired and wireless communications.

11. The method according to claim 1, wherein a cryptograph key information communication step is carried out in which said first communication device sends, via its second communication unit, cryptograph key information, which cryptograph key information is received by said second communication device via its second communication unit, said cryptograph key information being used for encrypting and/or encoding information which said second communication device sends and/or receives via its first communication unit,
and wherein said second communication device encrypts and/or encodes information which said second communication device sends and/or receives via its first communication unit, using said cryptograph key information.

12. The method according to claim 1, wherein a cryptograph key information communication step is carried out in which said second communication device sends, via its second communication unit, cryptograph key information, which cryptograph key information is received by said first communication device via its second communication unit, said cryptograph key information being used for encrypting and/or encoding information which said first communication device sends and/or receives via its first communication unit,
and wherein said first communication device encrypts and/or encodes information which said first communication device sends and/or receives via its first communication unit, using said cryptograph key information.

13. The method according to claim 1, wherein an identifier communication step is carried out in which said first communication device sends, via its second communication unit, an identifier, which identifier is received by said second communication device via its second communication unit, said identifier being used for identifying said first communication device,
and wherein said second communication device approves or rejects communications which said first communication device executes with said second communication device, using said identifier.

14. The method according to claim 1, wherein an identifier communication step is carried out in which said second communication device sends, via its second communication unit, an identifier, which identifier is received by said first communication device via its second communication unit, said identifier being used for identifying said second communication device,
and wherein said first communication device approves or rejects communications which said second communication device executes with said first communication device, using said identifier.

15. The method according to claim 1, wherein an identifier communication step is carried out in which said first communication device sends, via its second communication unit, an identifier, which identifier is received by said second communication device via its second communication unit, said identifier being used for identifying said first communication device,
and wherein said second communication device determines a range where said first communication device can use network resources in a wireless communication which said first communication device executes via its first communication unit, using said identifier.

16. The method according to claim 1, wherein an identifier communication step is carried out in which said second communication device sends, via its second communication unit, an identifier, which identifier is received by said first communication device via its second communication unit, said identifier being used for identifying said second communication device,
and wherein said first communication device determines a range where said second communication device can use network resources in a wireless communication which said second communication device executes via its first communication unit, using said identifier.

17. A communication device, said device comprising:
a first communication unit for wireless communication;
a second, different, communication unit;
a storage unit, and;
a control unit which sends guide information concerning communication forms usable by said first communication unit to other communication devices via said second communication unit.

18. A communication device, said device comprising:
a first communication unit for wireless communication;
a second, different, communication unit;
a storage unit, and;
a control unit which receives, from a second, different, communication device of the same type as this device, via said second communication unit of this communication device, guide information concerning communication forms usable by said first communication unit of said second communication device, and which determines communication parameters for use when this communication device and said second communication device communicate via their respective first communication units.

19. A record medium, said medium containing a program and being readable by a computer, which computer controls a communication device, which communication device has a first communication unit for wireless communication, a second, different, communication unit, and a storage unit, and said program letting said computer;
detect that this communication device becomes communicable with other communication devices, via said second communication unit, and;
send guide information concerning communication forms usable by said first communication unit, via said second communication unit, to said other communication devices.

20. A record medium, said medium containing a program and being readable by a computer, which computer controls a communication device, which communication device has a first communication unit for wireless communication, a second, different, communication unit, and a storage unit, and said program letting said computer;
detect that this communication device becomes communicable with other communication devices, via said second communication unit;
receive from a second, different, communication device of the same type as this communication device, via said second communication unit of this communication device, guide information concerning communication forms usable by said first communication unit of said second communication device, and;
determine communication parameters for use when this communication device and said second communication device communicate via their respective first communication units.

21. A program, said program letting a computer, which computer controls a communication device, which communication device has a first communication unit for wireless communication, a second, different, communication unit, and a storage unit;
detect that this communication device becomes communicable with other communication devices, via said second communication unit, and;
send guide information concerning communication forms usable by said first communication unit, via said second communication unit, to said other communication devices.

22. A program, said program letting a computer, which computer controls a communication device, which communication device has a first communication unit for wireless communication, a second, different, communication unit, and a storage unit;
detect that this communication device becomes communicable with other communication devices, via said second communication unit;
receive from a second, different, communication device of the same type as this communication device, via said second communication unit of this communication device, guide information concerning communication forms usable by said first communication unit of said second communication device, and;
determine communication parameters for use when this communication device and said second communication device communicate via their respective first communication units.
